(19) United States
(12) Patent Application Publication
(10) Pub. No.: US 2003/0208465 A1
(43) Pub. Date: Nov. 6, 2003

(54) Method for managing medical information and medical information management system

(75) Inventors: Gregory Yurko, Murrysville, PA (US); Kevin Bowen, Pittsburgh, PA (US); Mark D'Angelo, Harrison City, PA (US); Scott Doty, Carnegie, PA (US)

Correspondence Address: MICHAEL W. HAAS, INTELLECTUAL PROPERTY COUNSEL, RESPIRONICS, INC., 1010 MURRY RIDGE LANE, MURRYSVILLE, PA, 15668, US

(73) Assignee: Respironics, Inc.

(21) Appl. No.: 10/409,199

(22) Filed: Apr. 8, 2003

Related U.S. Application Data
(60) Provisional application No. 60/372,209, filed on Apr. 12, 2002.

(51) Int. Cl. G06F 7/00

(52) U.S. Cl. 707/1

(57) ABSTRACT

A computer-implemented method for managing medical information that includes the steps of: providing a central database of information having disparate data fields containing data, and performing an action based upon the data in the disparate data fields. The method includes of sorting, providing warnings or reminders, searching, organizing, transmitting, and presenting data from the database. The medical information management system includes a central database resident on a computing system. The central database has multiple disparate data fields containing data pertaining to patient-related information. A user interface communicates with the central database for accepting user input and transmitting system output. A visual display also communicates with the user interface to display the disparate data fields in selected or selectable formats. The system can include a report generating module, a device interface, and a compliance calculation module, all of which are in communication with the central database.

### CROSS REFERENCE TO RELATED APPLICATIONS

The present invention claims priority under 35 U.S.C. §1.119(e) from U.S. Provisional Patent Application Serial No. 60/372,209, filed Apr. 12, 2002, entitled “Method for Managing Medical Information and Medical Information Management System”.

### BACKGROUND OF THE INVENTION

1. Field of the Invention

The present invention relates to methods and systems for managing medically-related information, and, in particular, to a method and system that manages information pertaining to (1) durable medical devices used by a patient, (2) the treatment, diagnosis, and/or monitoring functions provided by those devices, (3) the use of the devices by the patient, and (4) other information relevant to the use of the medical devices by a patient.

2. Description of the Related Art

It is well known to treat a medical disorder or to diagnose, treat or monitor the condition of a patient using medical equipment. For example, patients suffering from a pulmonary or respiratory disorder, such as obstructive sleep apnea (OSA) or congestive heart failure, are often treated with a pressure support device, such as a continuous positive airway pressure (CPAP) device. A CPAP device delivers a flow of fluid to the airway of the patient throughout the patient's breathing cycle in order to “splint” the airway, thereby preventing its collapse during sleep. Examples of such CPAP devices are the REMstar® and Solo® family of CPAP devices manufactured by Respironics, Inc. of Pittsburgh, Pa.

It is also known to provide a bi-level positive pressure therapy, in which the pressure of fluid delivered to the patient's airway varies or is synchronized with the patient's breathing cycle to maximize the therapeutic effect and comfort to the patient. An example of pressure support devices that provide “bi-level” pressure support, in which a lower pressure is delivered to that patient during the patient's expiratory phase than during the inspiratory phase, is the BiPAP® family of devices manufactured and distributed by Respironics, Inc. of Pittsburgh, Pa. Such a bi-level mode of pressure support is taught, for example, in U.S. Pat. No. 5,148,802 to Sanders et al., U.S. Pat. No. 5,313,937 to Zdrojkowski et al., U.S. Pat. No. 5,433,193 to Sanders et al., U.S. Pat. No. 5,632,269 to Zdrojkowski et al., U.S. Pat. No. 5,803,065 to Zdrojkowski et al., U.S. Pat. No. 6,029,664 to Zdrojkowski et al., and U.S. Pat. No. 6,305,374 Zdrojkowski et al., the contents of each of which are incorporated by reference into the present invention.

It is further known to provide an auto-titration positive pressure therapy in which the pressure provided to the patient changes based on the detected conditions of the patient, such as whether the patient is snoring or experiencing an apnea, hypopnea, or upper airway resistance. An example of a device that adjusts the pressure delivered to the patient, based on whether or not the patient is snoring, is the Virtuoso® CPAP family of devices manufactured and distributed by Respironics, Inc.

An example of a pressure support device that actively tests the patient's airway to determine whether obstruction, complete or partial, could occur and adjusts the pressure output to avoid this result is the Tranquility® Auto CPAP device, also manufactured and distributed by Respironics, Inc. An exemplary auto-titration pressure support mode is taught, for example, in U.S. Pat. Nos. 5,203,343; 5,458,137; and 6,087,747, all to Axe et al., the contents of which are incorporated herein by reference. A further example of an auto-titration pressure support device that actively tests the patient's airway to determine whether obstruction, complete or partial, could occur and adjusts the pressure output to avoid this result is the Tranquility Auto CPAP device, also manufactured by Respironics, Inc. This auto-titration pressure support mode is taught in U.S. Pat. Nos. 5,645,053 and 6,286,508 both to Remmers et al., the content of which is also incorporated herein by reference.

In treating a patient using any of the above-described pressure support systems, each of which represents a mode of providing pressure support, it is often desirable to monitor various parameters associated with the use of such systems. For example, once a patient is diagnosed with a breathing disorder, he or she is prescribed a pressure support therapy, i.e., a mode of pressure support (CPAP, bi-level, or auto-titration) at a prescribed level or level or range of pressures. The patient's healthcare provider, such as that patient's physician or health insurance company, is often interested in ensuring that the patient actually uses the pressure support therapy. Thus, it is known to monitor a patient's compliance with the prescribed therapy by monitoring the usage of the pressure support device.

The Encore® data management system provided by Respironics, Inc. of Pittsburgh, Pa. is an example of a conventional system for managing information regarding a number of medical devices. This prior art management system allows for the input of information from a user, a direct link between the medical device and the system or the use of a temporary storage medium, such as a diskette, storage card or other medium. This system accepts specific information regarding the patient, the patient's device, the patient's device usage and other limited patient-specific information. After the information and data has been entered into the system, a patient may be selected and his or her medical data can be visually displayed to an end user, typically the home care provider.

While the Encore system does an adequate job monitoring the individual use of a pressure support system and various parameters about the system used by each patient, it is limited in its ability to monitor the equipment used by the patient or to cross-correlate the equipment used by a number of patients, with the compliance or effectiveness of such use. Further, this prior art information management system lacks a dynamic linking ability between like fields for different patients, and, therefore, is limited in its ability to present useful multi-patient data for any particular area of interest. Still further, this prior art information management system lacks the ability to search, group, sort and present data and reports directed to other areas of interest to a home care provider, a primary care provider, an insurer and a device/equipment manufacturer. In addition, prior art management systems lack the ability to effectively track referrals, manage interactions, manage reminders, create useful visual presentation of data and have other shortcomings as will become evident.

### SUMMARY OF THE INVENTION

Accordingly, it is an object of the present invention to provide a method for managing medical information and a medical information management system that overcomes the shortcomings of conventional medical information management methods and systems. In particular, it is an object of the present invention to provide a method for managing medical information and a medical information management system capable of monitoring the device or equipment used by a patient and to cross-correlate the equipment used by a number of patients with the compliance or effectiveness of such use.

It is a further object of the present invention to provide a method for managing medical information and a medical information management system having a dynamic linking ability between like fields for different patients, which provides an ability to present useful multi-patient data for any particular area of interest.

It is yet another object of the present invention to provide a method for managing medical information and a medical information management system that allows a user to search, group, sort and present data and reports directed to other areas of interest to a user, a home care provider, a primary care provider, an insurer and a device/equipment manufacturer.

It is an additional object of the present invention to provide a method for managing medical information and a medical information management system that effectively track physician referrals, monitors the effectiveness of clinicians responsible for managing patients, manages interactions, manages reminders and creates useful visual presentation of data.

It is a still further object of the invention to provide a method for managing medical information and a medical information management system that is provides reminder regarding upcoming events associated with a patient, such as when that patient is to have a component of their medical device replaced.

Accordingly, the present invention is directed to a computer-implemented method for managing medical information, including the steps of: (a) providing a central database of information that includes disparate data fields containing data; and (b) performing an action based upon the data content in the disparate data fields. In a preferred embodiment, the method includes the steps of: selecting a sort criterion for organizing a portion of the disparate data fields according to the sort criterion; formatting the organized portion of the disparate data fields in a presentable report; and presenting this report to a user. In the another embodiment, the method includes the steps of: selecting one or more of the disparate data fields; providing a threshold value for the selected data field; comparing the selected data field value with the data field threshold value; and presenting a signal to a user when the value for the selected data field equals the data field threshold value. In further preferred embodiments, the present invention provides methods for searching, organizing, transmitting and presenting data.

The present invention is also directed to a medical information management system including a central database resident on a computing system, and the central database includes multiple disparate data fields containing data pertaining to patient-related information. The system has a user interface in communication with the central database for accepting user input and transmitting system output. A visual display is in communication with the user interface and displays the disparate data fields in selected or selectable formats. In a preferred embodiment, the system includes a report generating module and a download management module, both of which are in communication with the central database. Further, in a preferred embodiment, the system includes sorting, searching, inputting and editing features.

These and other objects, features and characteristics of the present invention, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a schematic view of a medical information management system according to the present invention;

FIGS. 2-22 are screen shots of an exemplary embodiment of a method and system according to the present invention or exemplary screen shots of such embodiments;

FIGS. 23A-23E is an example of a compliance interaction report for an individual patient;

FIGS. 24A-242B is an example of a FOSQ general report for an individual patient;

FIGS. 25A-25B is an example of a cross-patient device mode report for multiple patients; and

FIGS. 26A-26B is an example of a cross-patient mask report for multiple patients.

### DETAILED DESCRIPTION OF THE PRESENTLY PREFERRED EXEMPLARY EMODIMENTS

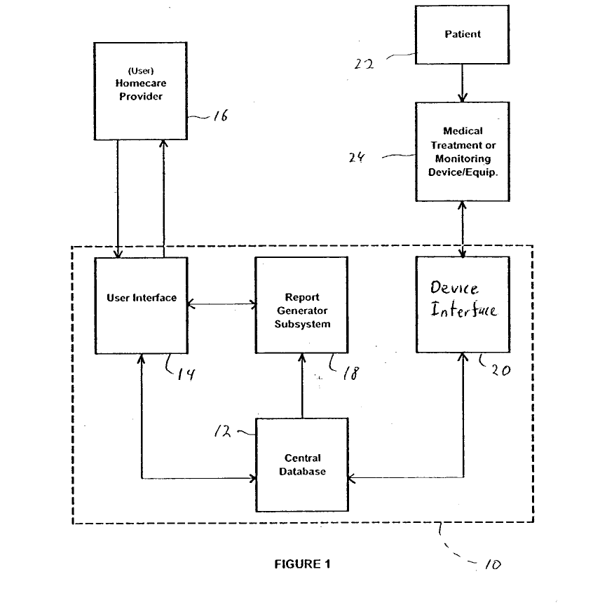

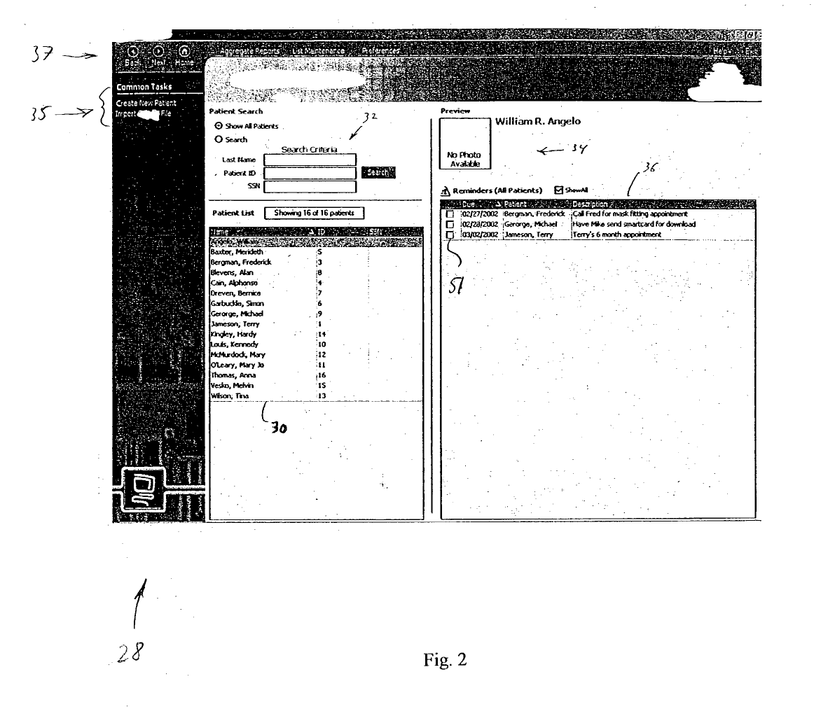

The present invention is directed to a computer-implemented method for managing medical information, as well as a medical information management system. A preferred embodiment of the system is illustrated in FIG. 1, and various screen shots of an exemplary embodiment are presented in FIGS. 2-24. The present invention also includes an apparatus capable of performing the method for managing medical information, and an apparatus for controlling and executing this method.

The computer-implemented method includes the steps of: (a) providing a central database of information that includes multiple disparate data fields; and (b) performing an action based upon the data content in at least one of these disparate data fields. It is this central database that contains all of the data and information of the data fields in an organized and systematic manner.

The data in the data fields is generally of a medical or patient-oriented nature and may include a patient name, a patient address, a patient identification number, patient contact information, patient social security number, patient date of birth, patient gender, patient marital status, patient ethnic category, patient occupation, patient disorder data, patient surgical data, patient medication, functional outcomes of a questionnaire (e.g., the Functional Outcomes of Sleep Questionnaires (FOSQ), Berlin, or Epworth questionnaires) inputs and results, insurance provider, insurance policy number, insurance group number, policy holder name, policy holder relationship, comments, patient photographic image, referring physician data, primary care provider data, home care provider, clinician data, contact date, contact time, contact name, contact information, home visit date, recommended contact date, recommended device repair date, recommended device maintenance date, home visit frequency, recommend contact frequency, recommended device repair or maintenance frequency, device type, device characteristics, device serial number, device prescription, prescription compliance, device compliance, compliance data, device usage dates, device usage information, session information, device physical settings, testing criteria, test inputs, testing results, equipment data, equipment replacement data, equipment maintenance data, facility data, therapy time, electronic communication data, database identification, file data, device/equipment images, and patient-specific data. As seen by this above representative listing of data for entry into the data fields of the central database, such data is generally patient-specific, or at least patient-associated.

When using the present invention in connection with the therapeutic treatment in monitoring of sleeping disorders, the patient-specific data may correspond to bed time, average hours of sleep, height, weight, neck circumference, Epworth sleepiness scale, blood pressure, diagnostic respiratory disturbance index (RDI), therapeutic RDI, minimum oxygen saturation, body mass index, and sleep facility name. While this method is employed for use in connection with devices that treat obstructive sleep apnea in a preferred embodiment, it is also envisioned that the present method can be used to gather and organize information pertaining to other medical devices (both therapeutic and diagnostic devices), such as ventilators, pressure delivery systems, oximeters, ventilatory support systems, oxygen concentrators, polysomnographic recorders or monitors, and other pressure support or therapeutic devices. It is further envisioned that the present method can be used to gather and organize information pertaining to accessories used with medical devices, such as patient interface devices (i.e., masks, cannulas), filters, humidifiers, tubing, exhaust ports, etc.

Overall, the present method includes three basic sub-systems or categories, namely, input, modification and presentation. In addition, the present method and system may also include searching capabilities for locating specific data.

In order to be useful, the initial step requires the input of information into the central database. This requires that the central database be created on a computing system and have the capability of containing disparate data fields. Data is transmitted to the computing system for entry onto the central database, with the data being entered into a predetermined data field on the database. Transmitting this data to the computing system can be achieved in many different manners, as well known in the art. For example, the data may be transmitted to the computing system directly from a user (for example, a user “keying” data into the computing system), a direct link between the computing system and another computing system, device, equipment, etc., a telecommunications data link (for example, a modem connection) or a temporary storage medium (for example, a diskette, a compact disk, smartcard, a back-up cassette, a portable storage drive, a temporary storage medium, etc.).

After the data has been transmitted or communicated to the computing system, this data must be organized and stored in the central database. It is also envisioned that this central database be multiple, linked sub-databases. For example, all of the data pertaining to a specific patient may be contained on a dedicated sub-database. Further, the central database may be resident on a stand-alone computing system, a home care provider network, a primary care provider network, an insurance network, a manufacturing network, or other network systems. The disparate data fields in the central database may also be resident on various discrete computing systems that are in a networked relationship, such that the central database has access to the data stored in and available from each discrete computing system. Further, the central database may include or have access to relational tables resident on the computing system. These tables associate data and data fields across multiple databases, sub-databases or sets of information.

In the preferred embodiment, the inputted data may include information used for the creation of patient records and associated data, patient interactions, patient prescriptions, patient medical and surgical histories, patient physician and clinician information, patient contacts, reminders, and patient functional outcomes of sleep questionnaire inputs and results. These various inputs may include any data available to or of interest to physicians, clinicians, home care providers, primary care providers, insurance companies, manufacturers and other end users.

In addition, the inputted data may include compliance data, which is data indicative of a patient's compliance with a prescribed pressure support therapy. Compliance data can include prescription compliance data or device compliance data, typically based upon device usage information, device prescription, and session information for a patient or user. This compliance data may be calculated on a subsystem or module or inputted to the present system and method from another system via a network, direct link, direct input, telecommunication data link, temporary storage media, etc. For example, the compliance data may be calculated and transmitted to the present method and system by the system, e.g., resident on the device or other computing device. An example of a system for measuring compliance suitable for use with the present invention is described and claimed in co-pending U.S. Provisional Patent Application Serial No. 60/406,247, filed Aug. 27, 2002, entitled “Method and System for Tracking and Monitoring Patient Compliance with Medical Device Usage Prescription,” the disclosure of which is incorporated herein by reference. In this embodiment, the total hours of use are entered as the amount of compliance time the device was used between the start date and the end date.

Once the data of interest is transmitted to the computing system and entered into the central database of information, the method and system also allow for the modification of this data. For example, a user may copy, edit, delete or move a patient record, a patient interaction, patient description information, patient medical and surgical history, patient physician or clinician information, reminders and other customizable data sets. In addition, the central database may be updated on a real-time basis or a periodic basis.

Once the data is entered into the disparate data fields of the central database and appropriately organized, the present method and system allows for its organized and formatted presentation. The method and system may include predetermined or pre-formatted reports for user selection. For example, this may be useful for reports that are typically and continually used for assessment purposes and should be at the user's “fingertips.” In a preferred embodiment, the present method includes the steps of: selecting a search criterion for organizing at least a portion of the plurality of disparate data fields according to the selected criterion; formatting the organized portion of the plurality of disparate data fields in a presentable report; and presenting the report to a user.

Along with the sort selection, a user may also group the data and the data fields according to specific criterion. This is particularly useful with common fields across multiple patients or patient groups. In this manner, using the linked-field nature of the central database, together with a specified sort criterion or grouping criterion, a user can view specified patient information across the entire set or a subset of the patient base. Importantly, the data can be grouped according to any criterion selected by the user. Further, the data can be sorted according to any criterion selected by the user.

After a user has selected grouping and/or sorting criteria, the method and system organizes the data according to these criteria. Next, the method and system presents this organized data to the user in a selected format or report form. The report may include lists, charts, diagrams, graphs, etc. It is also envisioned that a user can select and create his or her own form sets, which would provide for a customizable report format.

Another aspect of the preferred embodiment is the “reminder” functionality. In this embodiment, the method also includes the steps of: selecting at least one of the plurality of disparate data fields; providing or inputting a data field threshold value for the selected data field; comparing the selected data field data with the data field threshold value; and presenting a signal to a user when the selected data field data equals the data field threshold value. This data field threshold value may be set by the user. Alternatively, the data field threshold value may be set by the system and dependent upon the data in one or more of the disparate data fields. For example, a threshold value may be set to remind a user that a specific patient is using equipment in need of repair or replacement. The threshold value in this situation can be the number of days or hours that the equipment has been use. The actual time of use is compared with the threshold time value to determine whether repair or replacement is warranted.

For example, if a patient is using a pressure support system that includes a filter, an auto-generated equipment reminder may let the user, in this example the home care provider, know that the patient's filter is in need of replacement, whether due to usage, insurance company reimbursement policies or other criteria. Importantly, such reminders are able to be set based upon any criteria, regardless of whether it is user-generated or not. For example, reminders may be set or automatically generated based upon the safety data, time data, policy data, insurance data, respiratory data, patient data, reimbursement schedule data, etc. Further, the signal indicating that replacement is warranted may be an audible alarm, a visual display or a combination of the two. The visual display may be set by the system or may be inputted by the user. This aspect provides set or auto-generated reminders containing audiovisual data, such as customizable reminder messages.

In one exemplary embodiment of the present invention, the replacement schedule for a medical device or component is set into the system as the threshold value. That is, an insurance provider may reimburse a homecare provider according to a certain schedule for certain medical equipment used by a typical CPAP user, so that each CPAP user under the supervision of the homecare provider may be entitled to a fully reimbursed mask of brand X every 3 months. The system of the present invention monitors which patient's have brand X masks and the number of days that each such patient has been using their mask. The system automatically compares the threshold time period (3 month in this example) to the actual time period (days that mask was used) so that when three months have elapsed for any patient, a reminder is automatically generated for the healthcare provider to provide that patient with a new replacement mask. Of course, the paperwork, inventory control, and other aspects of providing the replacement equipment to the patient typically undertaken by the healthcare provider, such as the insurance forms needed in order for the healthcare provider to be reimbursed by an insurance company for this new mask, can also be generated and monitored by the system of the present invention.

In addition to the input, modification and presentation features of the present method and system, also included is a searching capability. This feature includes the steps of: selecting a search criterion for searching the plurality of disparate data fields in the central database; searching the plurality of disparate fields based upon the search criterion; and presenting the search results to a user. It is envisioned that any criterion or criteria may be used to appropriately locate the information which the user is seeking. For example, the user may simply wish to locate a patient record, and would search the patient's last name. However, if the searcher does not remember the name of the patient, but does remember some of the patient's other data, the searcher may simply enter the data that he or she does remember, and the search functionality will return results meeting the selected and specified criteria.

Along with the method, the present invention is also directed to a medical information management system 10, as illustrated in a preferred embodiment in FIG. 1. Medical information management system 10 includes a central database 12 resident on a computing system (not shown). Central database 12 includes multiple disparate data fields, and each of these data fields includes data pertaining to patient-related information.

Medical information management system 10 also includes a user interface 14, which is in communication with central database 12 and serves to accept user input and transmit system output. User interface 14 may be a stand-alone or integrated computing system and, in a preferred embodiment, is a graphic user interface, which allows easy and effective data input, data manipulation and data presentation. User interface 14 preferably includes drop-down menus and selections for quick entry and access. Further, these drop-down menus and lists are customizable by a user. In order to increase the functionality of user interface 14, the user's position on a screen can be tracked and re-established when a user returns to a particular screen.

In order to effectively input, modify, or view the data, medical information management system 10 and/or user interface 14 may also include a visual display (not shown) in communication with user interface 14 for displaying the system and/or software components. Further, the computing system typically includes a central control module for executing high-level control and operation of medical information management system 10.

As seen in FIG. 1, in this preferred embodiment, a home care provider 16 may directly input, modify, search, and select data contained in central database 12 via user interface 14. In addition, home care provider 16 may select data in the data fields for presentation in specified formats. As discussed above, these formats can be user-specified or predefined. While the user in this embodiment is a home care provider 16, it is also envisioned that the user can be a primary care provider, an insurer, a physician, a clinician, a manufacturer, a patient, etc.

In a preferred embodiment, the medical information management system 10 also includes a report generator subsystem 18, which receives the grouping or sorting criteria for organizing all or a portion of the data fields, formats this organized portion of data fields in a presentable report, and transmits the report through user interface 14 to the visual display of the user or home care provider 16. Home care provider 16 may specifically select report types, grouping criterion, sorting criterion, and other organizational inputs, which are transmitted from user interface 14 to report generator subsystem 18.

In a preferred embodiment, medical information management system 10 also includes a device interface 20. Device interface 20 is in communication with central database 12 and is able to receive, manage and transmit data to the central database. As discussed above, device interface 20 can receive and manage information from a variety of systems and devices, such as direct user input, direct physical links, telecommunication data links, and temporary storage media. It is also envisioned that device interface 20 is capable of both downloading and uploading information to and from medical information management system 10 and other data entry points.

In the preferred embodiment, data is entered into central database 12 via device interface 20 from a patient 22 and/or a medical treatment or monitoring device 24. Of course, it is envisioned that patient 22 may input information into medical treatment or monitoring device or equipment 24 and, in turn, the device or equipment transmits this information to central database 12 via device interface 20. Device interface 20 is also capable of controlling, modifying, formatting, manipulating, and performing other data-related tasks on device 24 or a temporary storage medium. Published PCT patent application no. WO 01/32069 discloses a technique for performing such tasks using an external medical device or a temporary storage medium, such as a smart card.

The present method and system allows the user to record the name of the referring physician associated with each patient and/or with each interaction with a patient. Typically, a home care provider is only authorized to perform a subset of activities with a patient, without a referral from the patient's physician. By tracking this information in the system for each interaction with each patient, the method and system can provide valuable information through its reports. A report can be generated, which shows trends in referrals, and this report can be used to determine, over a long period of time, which physicians are referring more or less patients. This information would be useful for the home care provider to monitor the sources of their business. Another type of report using this information would show the home care provider referral information organized regionally. This report would serve a similar purpose in helping the home care provider to visualize the business.

The present method and system further allows the user to record the name of the clinician associated with each patient or associated with each interaction with the patient. By tracking this information, the method and system can provide valuable information through its reports. A report can be generated, for example, that shows how well, e.g., through FOSQ scores, patients being supervised by a particular clinician or group of clinicians are progressing through their treatment. This information would be useful for the home care provider or insurance company to monitor the performance and the clinicians supervising the patient that are also under the supervision of the homecare provider. Similar tracking can be done based on the referring physician.

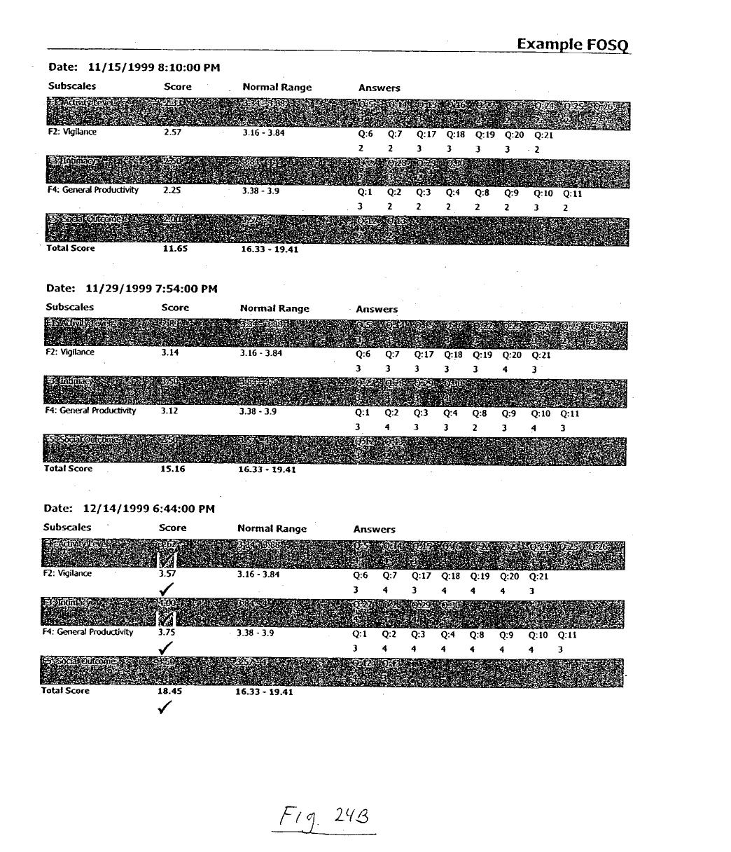

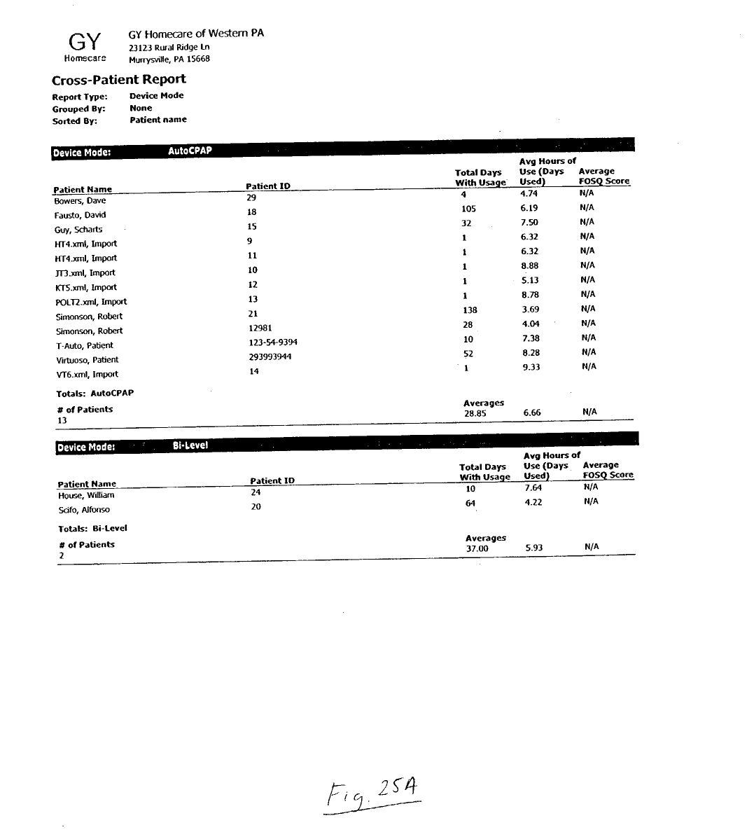

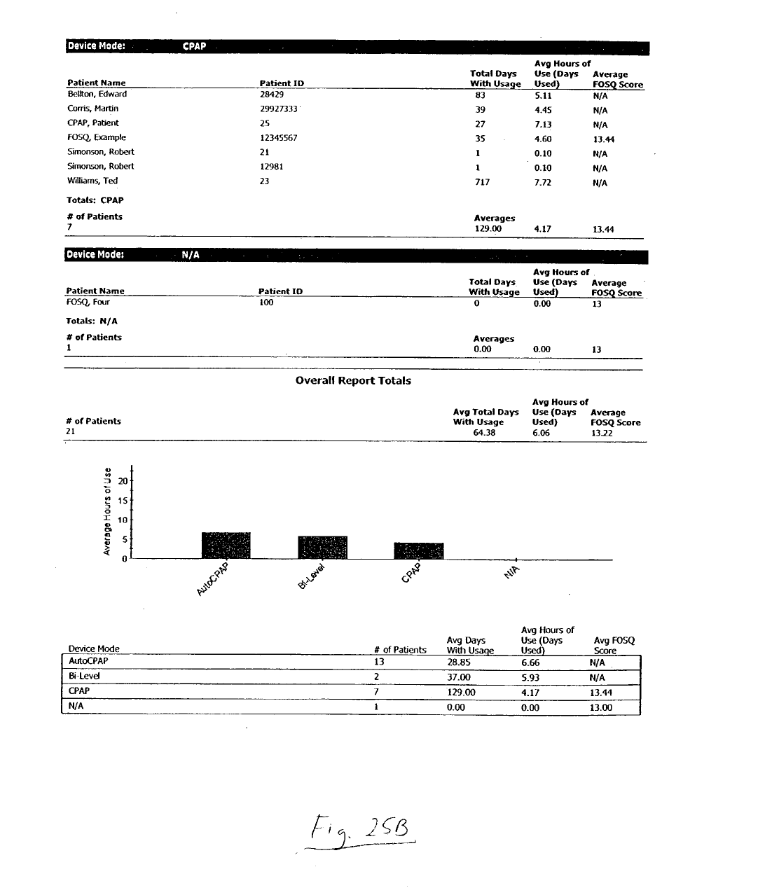

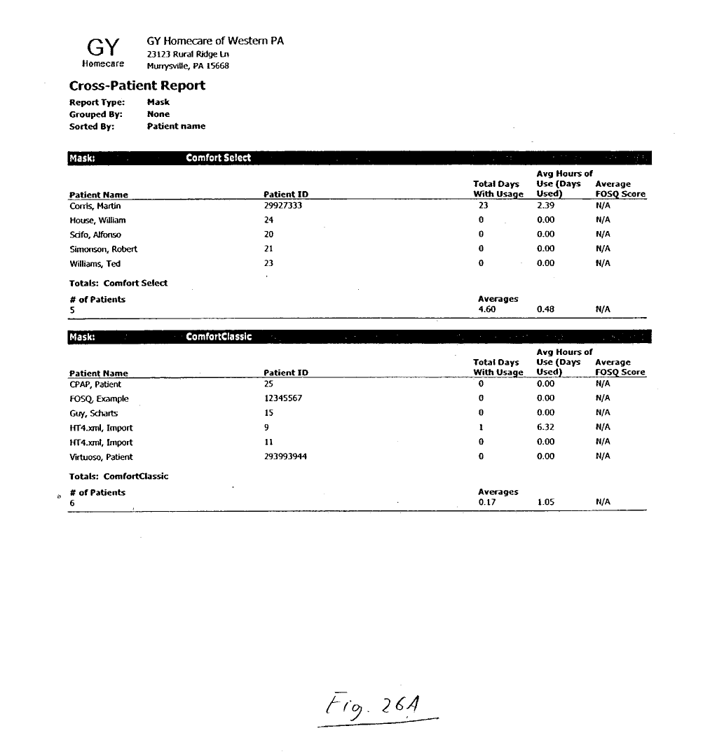

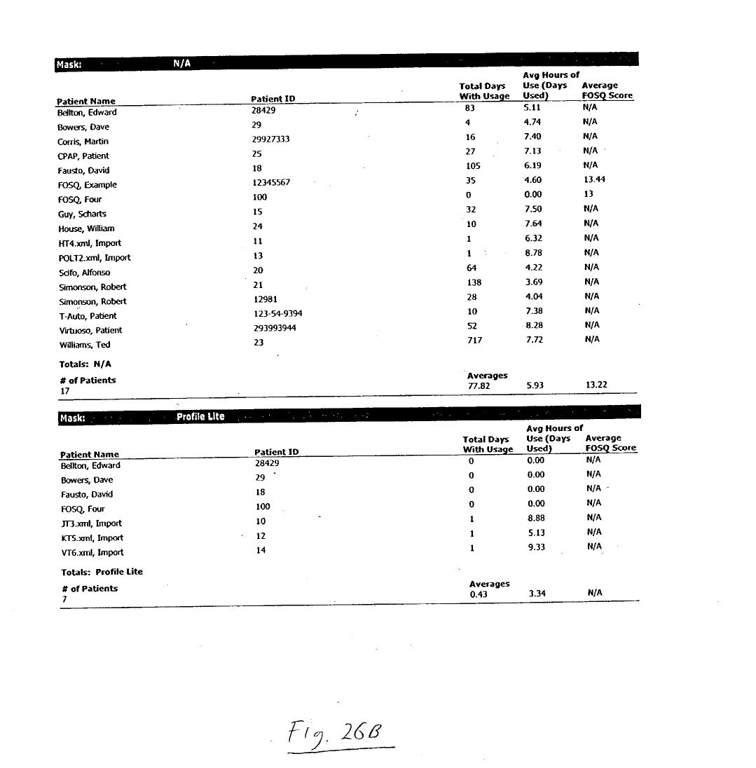

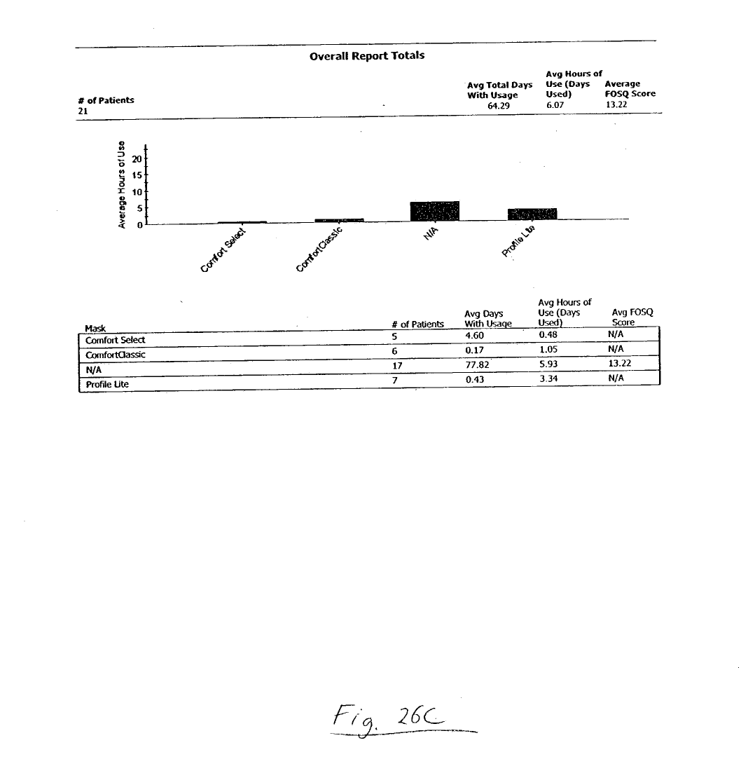

As discussed above, because the inputted data may include compliance data, the present method and system can conduct compliance calculations, which typically entails comparing a patient's prescription with that patient's session or device usage information. The device usage information can be directly uploaded from the device to the system, or, alternatively, a user can input this information into the system. Next, the system performs the necessary calculations or comparisons to determine whether a patient is compliant with his or her prescription. This “compliance report” graphically and visually depicts a patient's compliance. An example of such a compliance report is seen in FIGS. 25A-26B.

FIGS. 2-24 are screen shots of one exemplary method and system of the present invention. These screen shots are presented to a user, such as homecare provider 16, via user interface 14. The implementation illustrated in FIGS. 2-24 is meant to be only one representative implementation of a software method and system for managing medical information. This information is not meant to be limiting in any manner.

FIG. 2 illustrates and exemplary embodiment of a home page 28 or set starting point for the information management system of the present invention. Home page 28 allows the user to view the patient list in a patient list field 30 and other specific patient-related data, such as the patient name, identification number, and social security number. Patient list field 32 may show all of the patients in the central database, or may show the results of a search for a specific patient or group of patient's based on certain search criteria. In this implementation, the user may search on the patient's last name, the patient identification number, or the patient's social security number in patient search field 32. Of course, other search criteria may be used depending on the criteria assigned to the patients in the database, including searching for groups of patients where all of the patients in the group have a common search criteria. A patient can be deleted from the database by right-clicking on the desired patient in patient list field 32. In which case, the user is given the option to open the information pertaining to that patient by going to a patient home page discussed below or to delete the patient.

Once the patient list is displayed, the system may display a preview photograph of the patient, along with his or her name in a patient personal field 34. Also on this home page, reminders may be displayed for one or more patients, listing the due date, patient name and description of what action must be taken in a reminder field 36. The home page also includes a navigation field 37 at the top of the page that includes “back”, “next”, “home” selections for moving among the various windows in the system. Navigation field 37 also includes “aggregate reports”, “list maintenance”, “preferences”, “help” and “exit” selections, that are explained in detail below. Finally, home page 28 includes a toolbar 35, entitled “common tasks” that allows the user to perform specified tasks, such as create a new patient for entry into the database, and a import file.

It can be appreciated that other fields can be provided on homepage 28. For example, fields can be provided that facilitate travel between the various pages of the system and for displaying information, such as help information, printing information, advertising, or any other information programmed into the system. The users accesses other screens from home page 28 by clicking on the appropriate area of the screen, using a mouse, for example, as is known in the art.

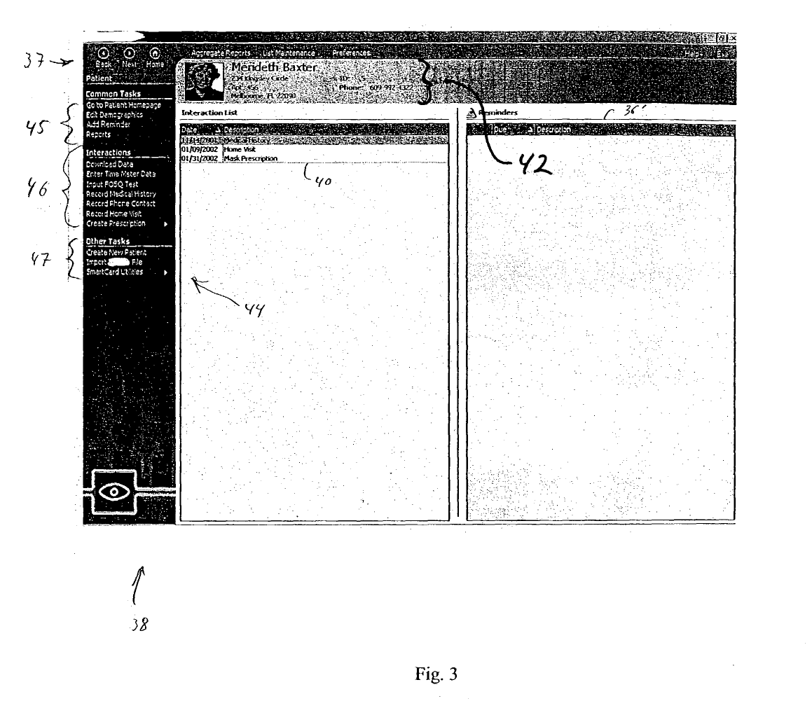

FIG. 3 illustrates a patient home page 38, which includes certain patient information, a listing of patient interaction description and dates, together with patient reminders in a reminder field 36′. A patient interaction field 40 lists the individual interactions that have taken place with that particular patient. The specific example shown includes three interactions listed in patient interaction field 40, namely a medical history interaction, a home visit, and a mask prescription. A patient interaction can be deleted from the database by right-clicking on the desired interaction in patient interaction field 40. In which case, the user is given the option to delete the interaction. The present invention also contemplates that right-clicking on a patient interaction presents the user with other options regarding that interaction, including editing the interaction, viewing an interaction report, and printing an interaction report. An interaction report is a listing of the information entered through a particular type of patient interaction.

Patient home page 38 also includes a patient display field 42 that includes detailed information, such as name, address, ID, phone number, and photo of the patient. In addition, patient home page 38 includes a toolbar 44 that includes a common tasks section 45, an interactions section 46, and an other tasks section 47, each of which provides tasks that can be conducted with respect to each patient. Patient home page 38 is accessed, for example, by selecting a patient from patient list 30 or by searching for the patient via search field 32.

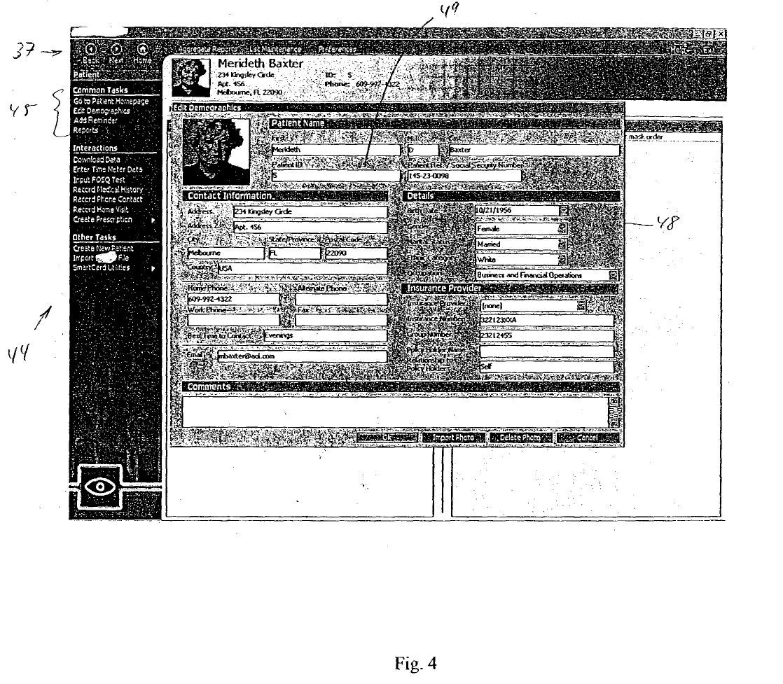

FIG. 4 illustrates an edit demographics screen 48 that allows a user to edit the demographics of a patient including importing and deleting the patient's photograph. Edit demographics screen 48 is accessed, for example, by selecting the “edit demographics” item listed in common tasks section 45 of toolbar 45 from patient home page 38. In this illustrated exemplary embodiment, using the edit demographics screen the user can add, edit or delete the data fields corresponding to the patient's name, patient identification number, patient's social security number, patient contact information, patient date of birth, patient gender, patient marital status, patient ethnic category, patient occupation, insurance provider, insurance number, group number, e-mail, best contact time, policy holder, relationship to policy holder and other comments. It is to be understood that other information can be included in addition to or in place of those specifically listed above, such as the referring physician, primary care physician, specialists, or other caregivers associated with that patient.

As noted above, a patient identification is preferably associated with each patient, which is shown in a patient identification field 49. This identification can be any letter, number, letter-number combination, or other code that complies with the user's filing system. The present invention contemplates that if no entry is made into field 49, for example, when a new patient is being created, the system will generate a unique identification number for each new patient record, preferably in compliance with the user's existing patient identification scheme. The patient identification number may always be edited using edit demographics screen 48.

Edit demographics screen 48 is also displayed when a user selects the “create new patient” item listed in the common tasks section of toolbar 35 from home page 28. However, in this case, because it is a new patient, the fields in screen 48 are empty or contain default information. Upon filling in the appropriate fields, the new patient information is saved into the database by selecting “ok” as the bottom of screen 48.

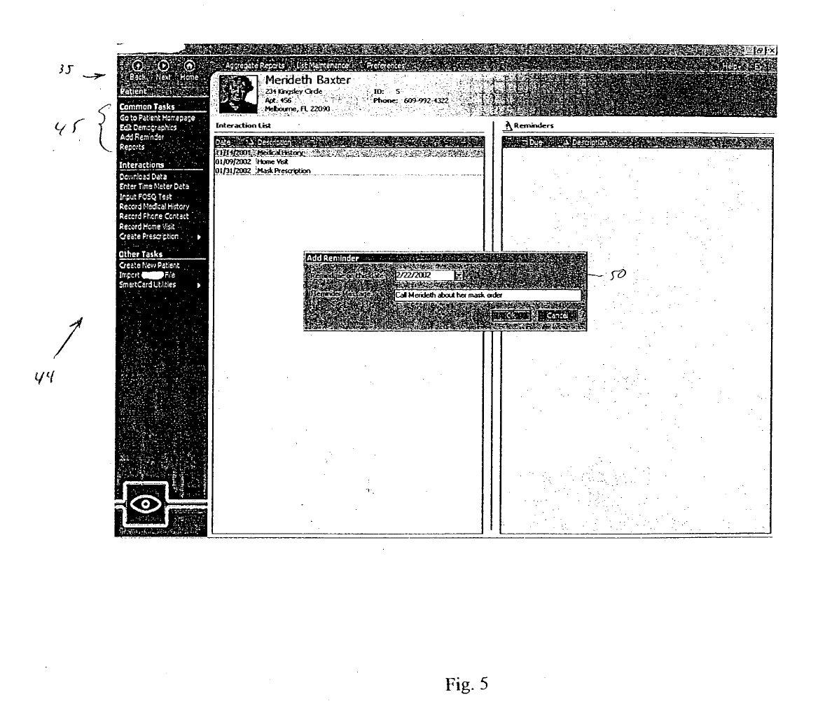

FIG. 5 illustrates an add reminder screen 50 for manually adding a reminder or data field threshold value to the central database. In this embodiment, the user can select the date for initiating the reminder, as well as the message to be displayed. This message to be displayed can be selected from a drop down list or typed in manually. The reminder will show up in reminder field 36′ on patient's home page 38, as well as in reminder field 36 on main home page 28, if selected. Add reminder screen 50 is also displayed when a user selects the “add reminder” item listed in the common tasks section 45 of toolbar 44 from patient home page 38. A reminder shown in reminder field 36′ or 36 can be edited by selecting the reminder from this field. In which case an edit reminder screen that is substantially the same as add reminder screen 50 will appear in which the date or reminder message can be changed. A reminder shown in reminder field 36 or 36′ is deleted by clicking on a checkbox 51 (see FIG. 2) that is displayed with each reminder. In a preferred embodiment of the present invention, only reminders due within the next three days are displayed, unless a “show all” function associated with reminder field 36 or 36′ is selected. Reminders that are due within the next three days or that are overdue are displayed in red, and all the remaining reminders are displayed in black.

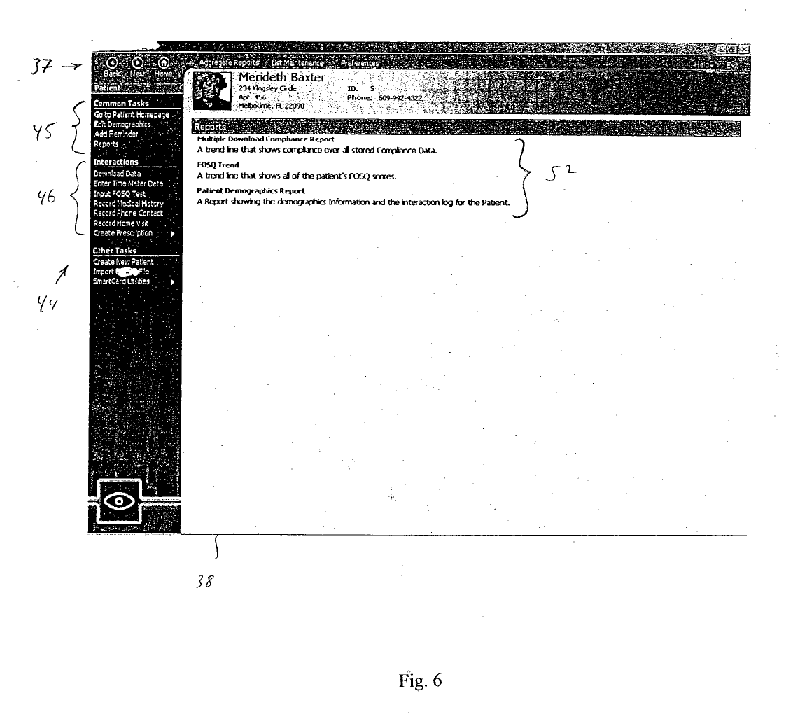

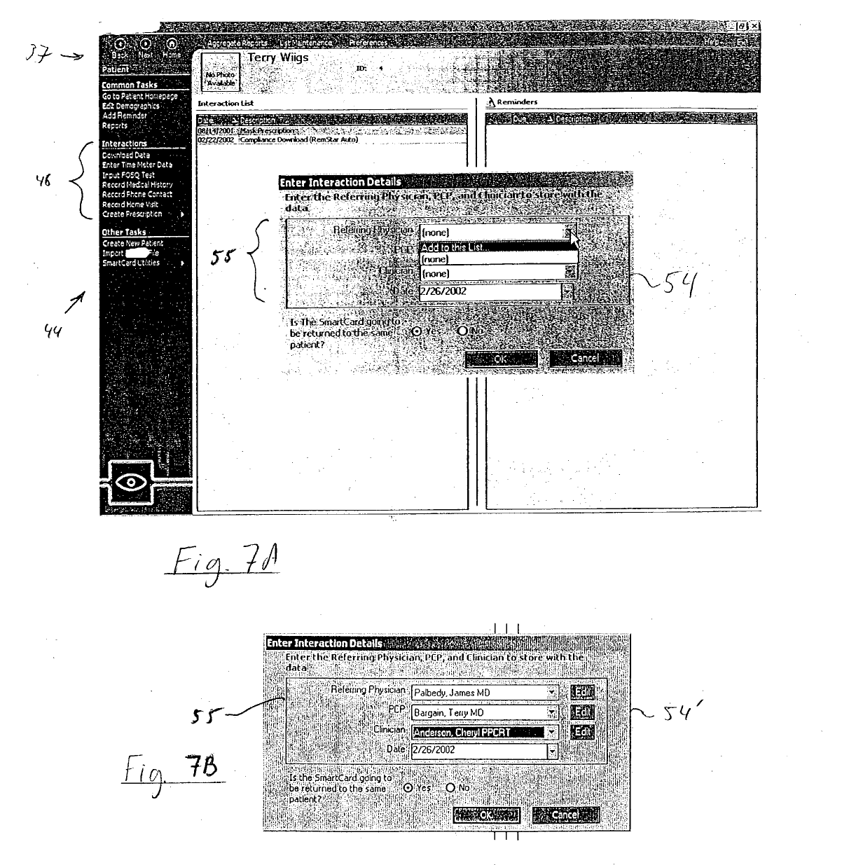

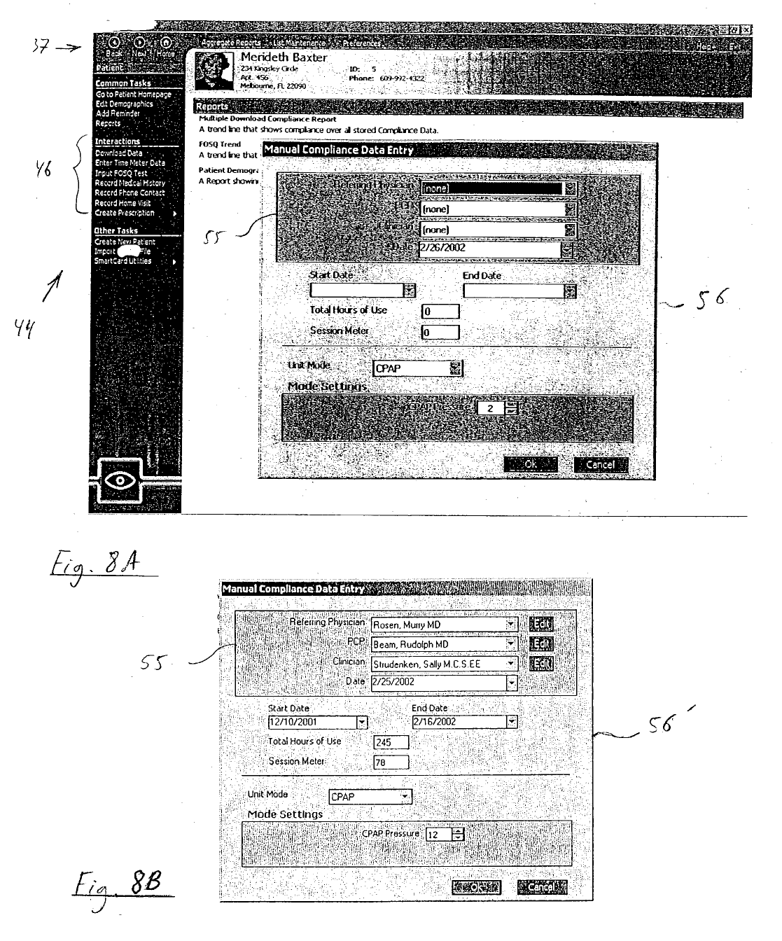

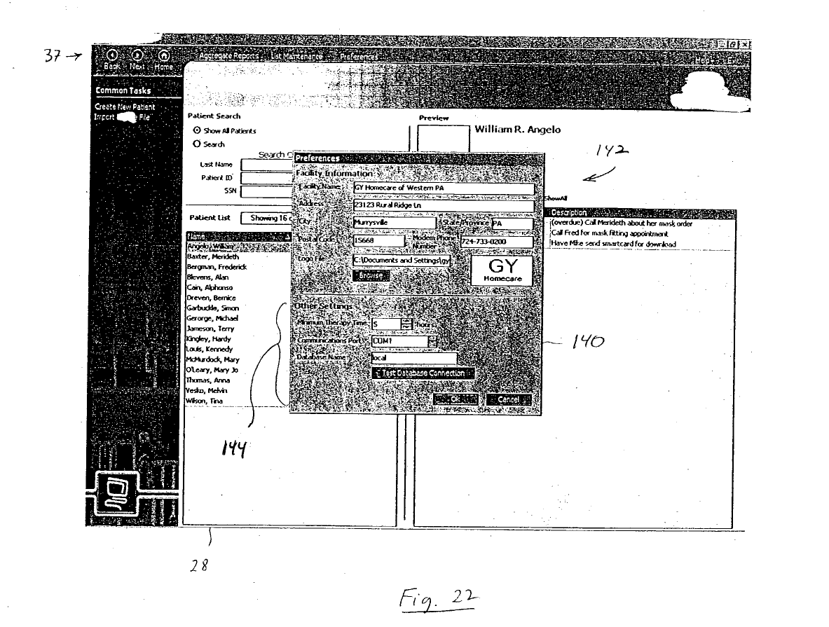

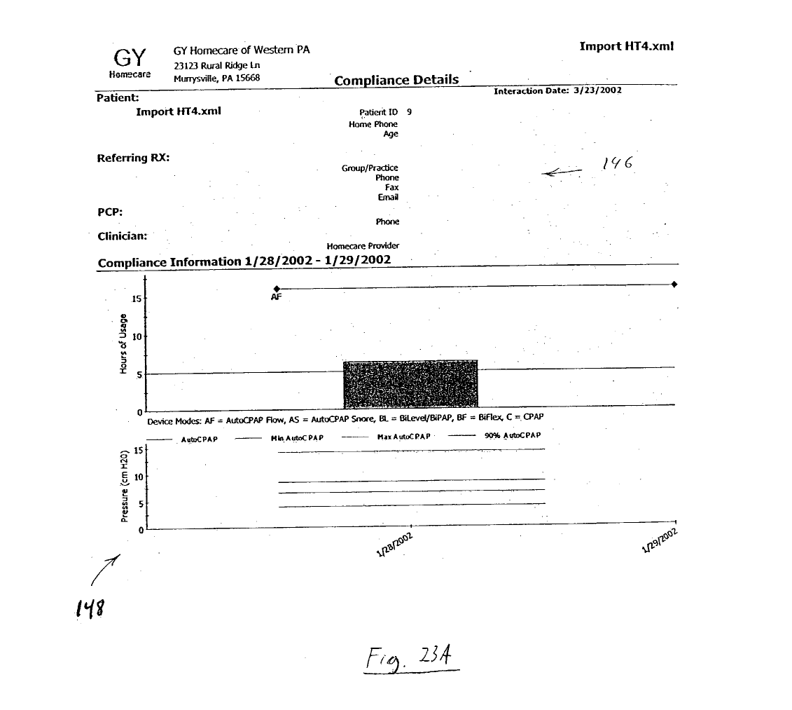

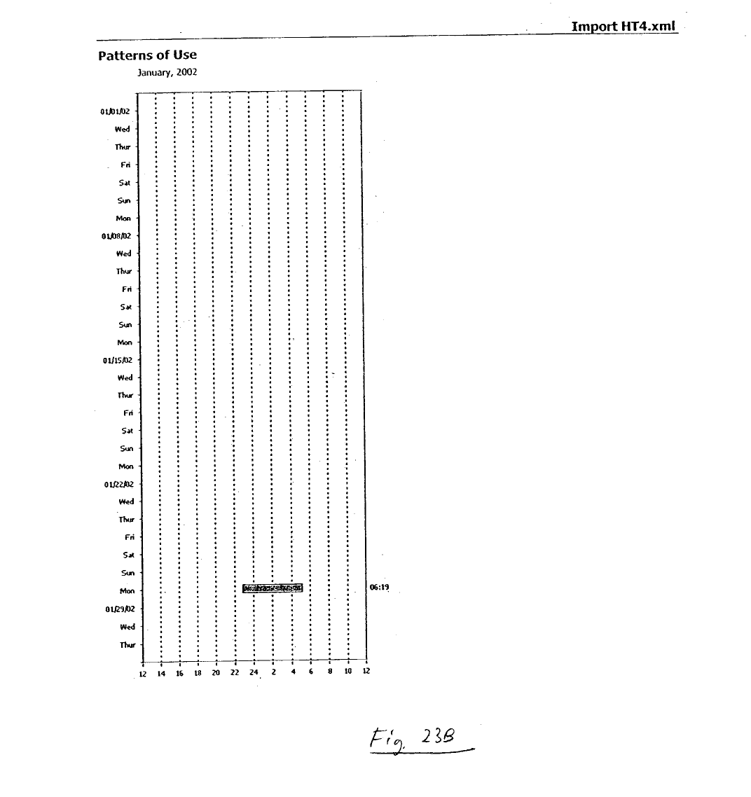

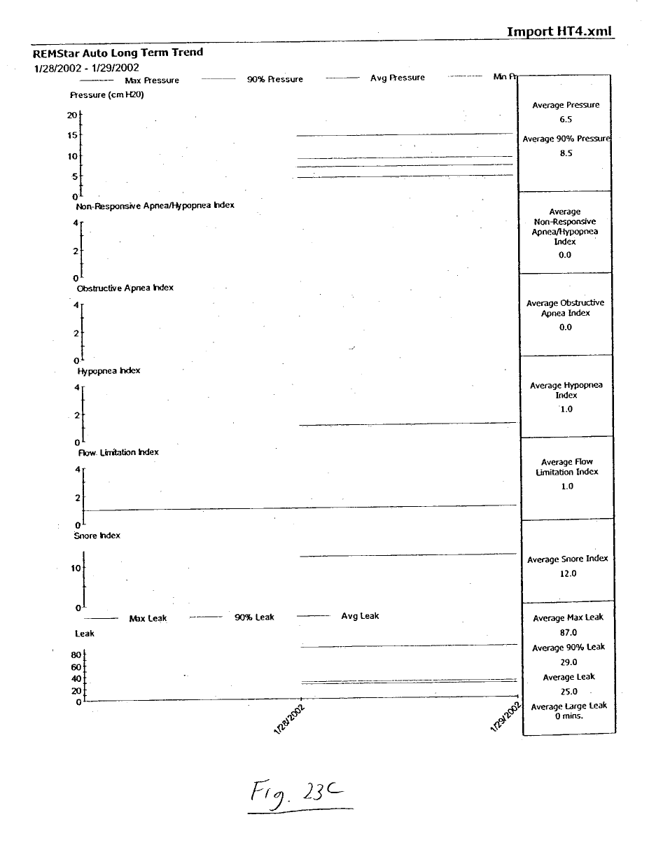

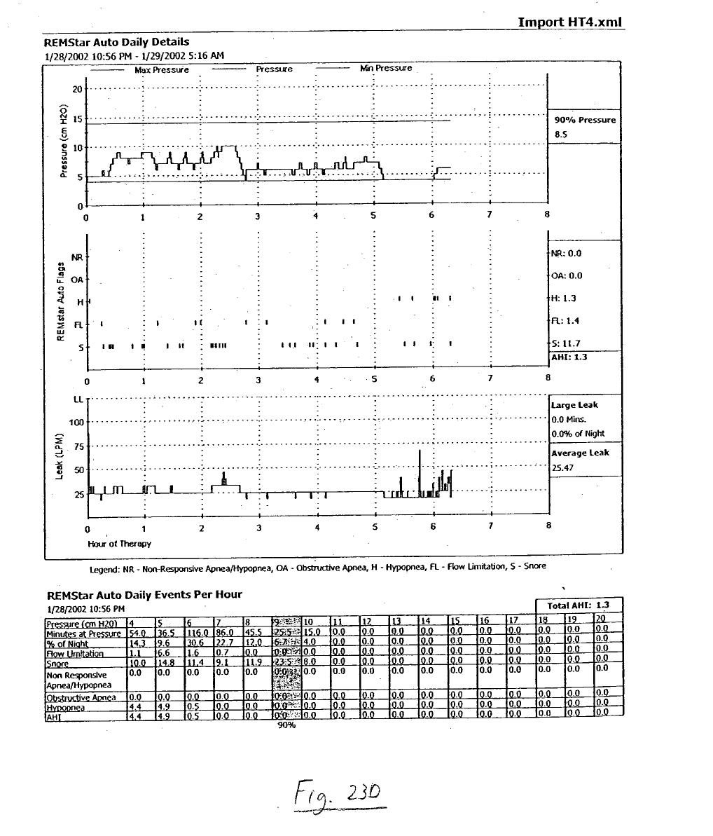

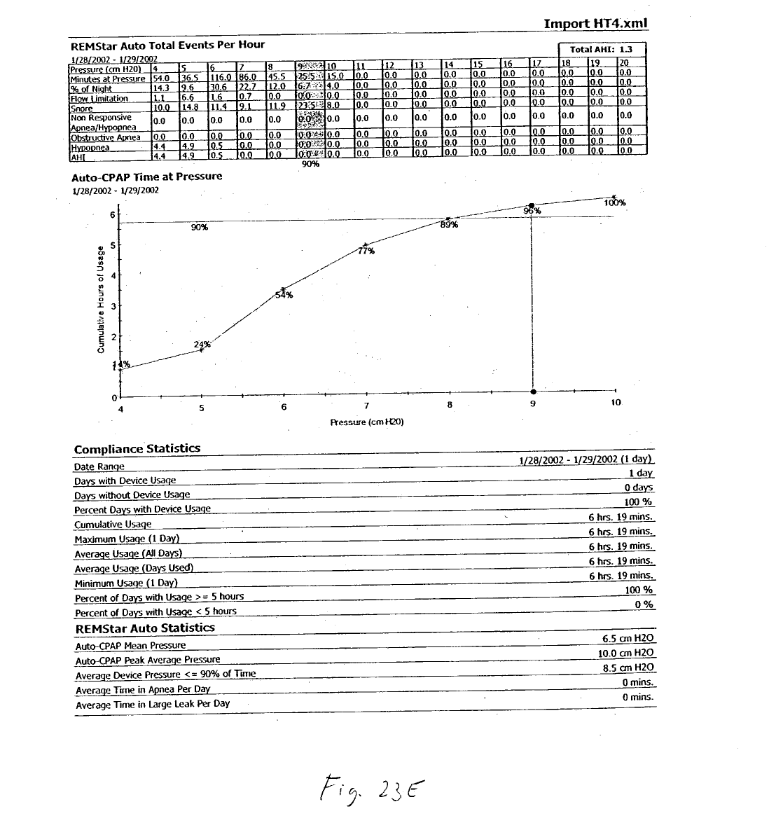

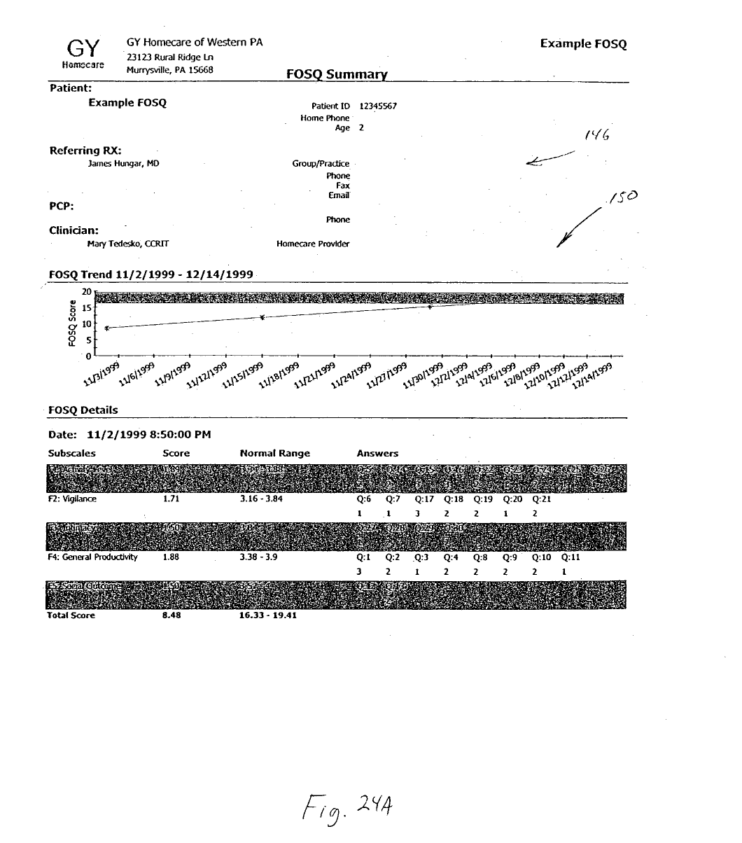

FIG. 6 illustrates a reports screen 52 listing the predetermined reports available for an individual patient. These reports include, but are not limited to, a compliance report that tracks the patient usage of the medical equipment (see FIGS. 23A-23E), an FOSQ trend report (see FIGS. 24A-24B), and a patient demographics report. Reports screen 52 is accessed, for example, by selecting the “reports” item listed in common tasks section 45 of toolbar 44 from patient home page 38. Each of these available reports can be generated by selecting, i.e., clicking, on the desired report from reports screen 52. The patient demographics report, when selected, displays a chronology of patient interactions, which are discussed below.

The present invention allows patient interactions to be recorded into the system. These interactions are listed in interactions section 46 of toolbar 44 under the heading “Interactions” and include, but are not limited to, the following interactions: downloading data into the system, entering time meter data into the system, recording the medical history of a patient, input the results of a FOSQ test, recording a phone contact with a patient, recording an in-person or home contact with the patient, and creating a prescription for a patient. Each interaction can be entered using toolbar 44 by clicking on the item in interactions section 46.

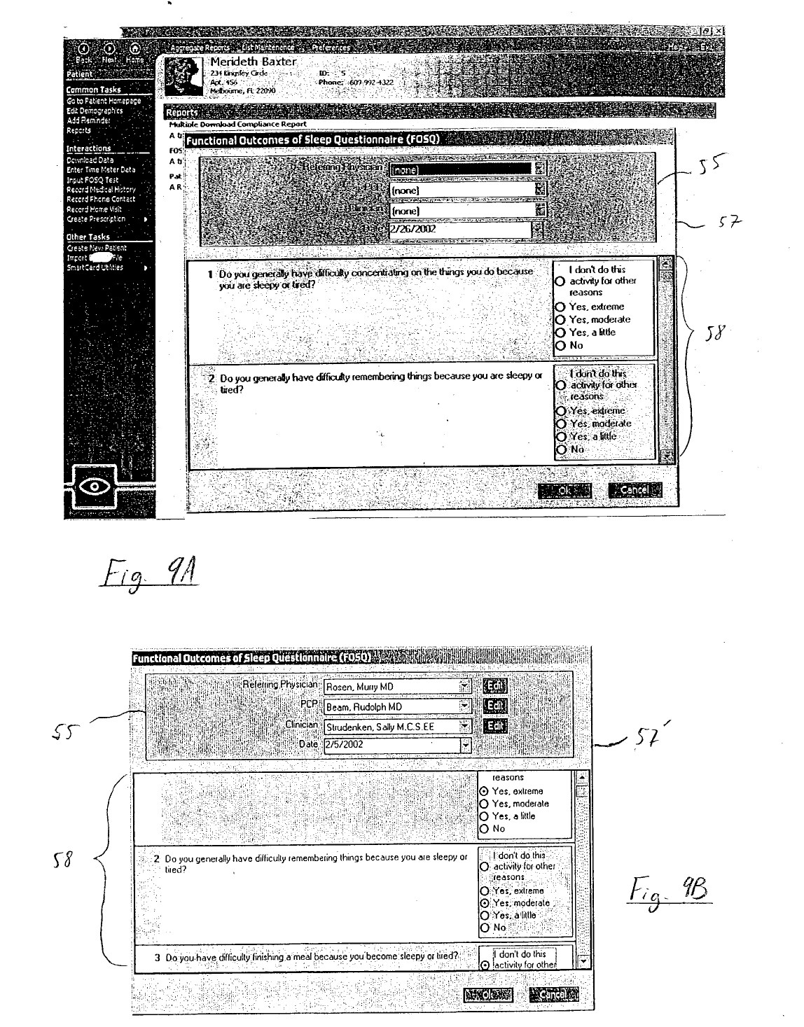

FIG. 7A illustrates an interaction input screen 54 that is displayed when the user selects the “download data” item from interactions section 46. The “download data” item is selected when the user wants to download patient data from a medical device, such as a pressure support system or patient monitor, or to download data from a storage medium, such as a smartcard in communication with the central database 12 via device interface 20. Examples of data that is downloaded from a pressure support system is the compliance data or hours of use. It is also known to use a pressure support system to provide a survey to a patient, such as a FOSQ test. The results of the survey can be collected via the pressure support system and downloaded to the central database. Rather than download such information directly from the pressure support system to the database, the present invention also contemplates providing this information on a removable storage medium, such as a Smartcard, when is the coupled to the central database for downloading the data stored thereon to the database. Before the data is downloaded, interaction input screen 54 is displayed.

Interaction input screen 54 includes a caregiver field 55 for entering the patient's referring physician, the patient's primary care provider (PCP), the clinician attending to the patient, and a date. All of these fields are modifiable prior to entry using any conventional technique. The present invention contemplates that the information management system has the capability using conventional techniques to determine, either automatically or manually, the type of device connected to the system from which data is to be downloaded. Depending on the type of device, further information or questions can be provided in screen 54. For example, if the system recognizes or is instructed that patient data is being downloaded from a Smartcard, interaction input screen 54 includes a question asking the user whether the Smartcard will be returned to the same patient.

FIG. 7B illustrates an interaction input screen 54′ that is displayed when a download data interaction is selected for editing by right-clicking on a download interaction from the patient home page and selecting the edit option. It can be appreciated that interaction input screen 54′ is similar to interaction input screen 54 except for the inclusion of “edit” buttons associated with the fields in the screen.

FIG. 8A illustrates a manual compliance data entry input screen 56 that is displayed when the user selects the “enter time data” item from interactions section 46 of toolbar 44. Manual compliance data entry input screen 56, like interaction input screen 54, includes caregiver field 55 that allows the user to input the referring physician, the primary care provider, the clinician, and the date. Further, in this embodiment, the date when the patient began using a device, the date when the patient stopped using the device, the total hours of use, the session meter, the unit mode and the device pressure delivery value are entered. The total hours of use should be entered as the amount of compliance time the device was used between the start date and the end date. If compliance time is not available, the blower hours, i.e., hours the blower was operating, should be entered. It should be noted that a session meter for measuring compliance time may not be available on all medical devices.

Some medical devices are capable of operating in more than one mode. For example, pressure support system exist that are capable of operating in a CPAP or a bi-level mode of pressure support. The present invention contemplates that the mode operation can be for indicated in the “unit mode” portion of manual compliance data entry input screen 56. The “mode settings” portion of manual compliance data entry input screen 56 is used to enter the settings for the medical device in the selected operating mode. For example, for a pressure support system operating in an CPAP mode, the prescribed CPAP pressure is entered here. For a bi-level system, the inspiratory positive airway pressure (IPAP) and the expiratory positive airway pressure (EPAP) are entered in the “mode settings” portions of manual compliance data entry input screen 56.

FIG. 8B illustrates a manual compliance data entry input screen 56′ that is displayed when an enter time meter data interaction is selected for editing, which is accomplished by right-clicking on an enter time meter data interaction from the patient home page and selecting the edit option. It can be appreciated that manual compliance data entry input screen 56′ is similar to manual compliance data entry input screen 56, except for the inclusion of “edit” buttons associated with one or more of the fields in the screen.

Rather than completing a survey, such as the FOSQ test, using a remote device, as discussed above with respect to FIG. 7, the present invention also contemplates that the survey can be complete using the information management system of the present invention. More specifically, a survey, such as the FOSQ test, can be executed when the user selects the “input FOSQ test” item from interactions section 46 of toolbar 44. FIG. 9 illustrates an FOSQ input screen 57 that is displayed when this selection is made. FOSQ input screen 57 includes caregiver field 55, as discussed above, to enter the referring physician, primary care provider, clinician, and the date. FOSQ input screen 57 also includes a questionnaire field 58 where the questions are presented and the answers to the questions are received. This FOSQ data is used in diagnosing and treating certain sleep disorders and represents a measure of the patient's quality of life. It can be appreciated that other questionnaires can be used.

FIG. 9B illustrates a FOSQ input screen 57′ that is displayed when an input FOSQ test interaction is selected for editing, which is accomplished by right-clicking on an FOSQ interaction from the patient home page and selecting the edit option. It can be appreciated that FOSQ input screen 57′ is similar to FOSQ input screen 57, except for the inclusion of “edit” buttons associated with one or more of the fields in the screen.

The present invention also contemplates that other measures of a patient's health or treatment effectiveness can be monitored by the information management system of the present invention. For example, the lung function of patient's suffering from asthma or other respiratory disorders often are monitored by means of a spirometer or the other respiratory function testing device. The results of these monitors can be conveyed directly to the information management system through the device interface discussed above or manually entered. These results can be correlated to physicians, clinicians, treatments, products used by such patients or other monitored criteria to allow the user of the system to track the patient or populations of patients. For example, the results of the lung assessment tests for a group of patients associated with a particular clinician can be monitored or the test results for a group of patients using a particular treatment can be monitored to determine how well the effectiveness of the clinician. Likewise, similar data for different clinicians or treatments can be compared to determine which clinician or treatment appears to be more effective.

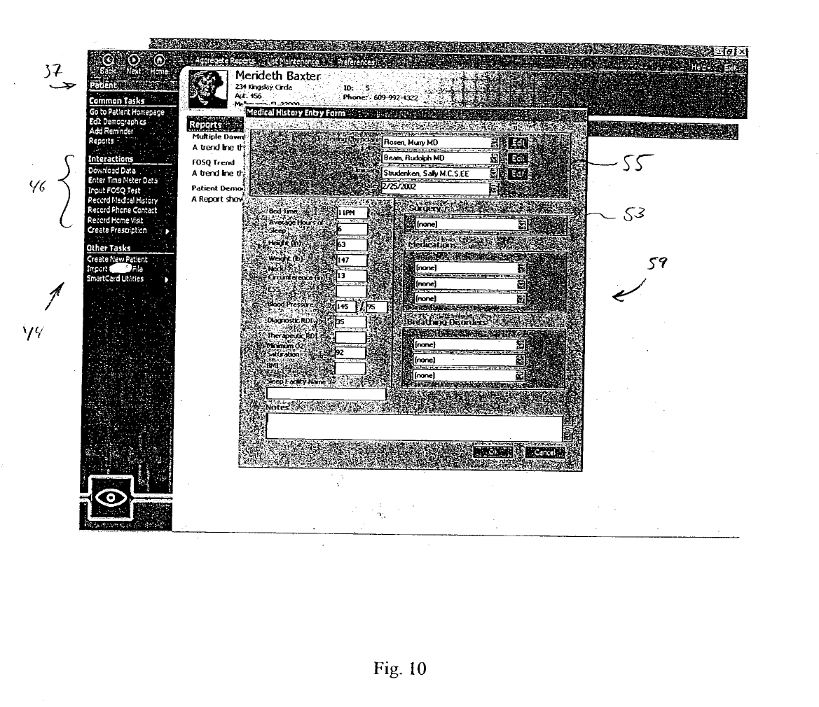

FIG. 10 illustrates a medical history entry form screen 53 that is displayed when the user selects the “record medical history” item from interactions section 46 of toolbar 44. Medical history entry form screen includes caregiver field 55 that allows the input of a referring physician, the primary care provider, the clinician, and the date. Medical history entry form screen 53 also includes medical information fields 59 in which information regarding the patient and the patient's medical history is entered. This information, includes but is not limited the following: bedtime, average hours of sleep, height, weight, neck circumference, ESS, blood pressure, diagnostic RDI, apnea hypopnea index (AHI), therapeutic RDI, minimum oxygen saturation, BMI, sleep facility name, surgery information, medication information, breathing disorder information, and other random notes.

It should be noted that the medical history entry form screen shown in FIG. 10 includes “edit” buttons. The medical history entry form screen first displayed when selecting the “record medical history” interaction from toolbar 44 need not include such buttons.

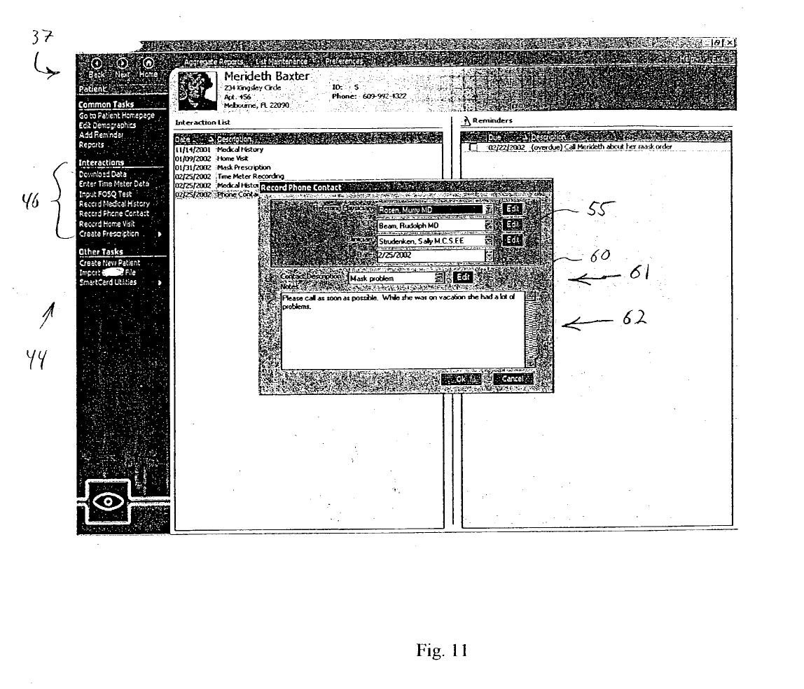

FIG. 11 illustrates a record phone contact input screen 60 that is displayed when the user selects the “record phone contact” item from interactions section 46 of toolbar 44. Record phone contact screen 60 includes caregiver field 55 that allows the input of the referring physician, the primary care provider, the clinician, and the date. Record phone contact screen 60 also includes a contact description field 61, and a notes field 62 for entering a description related to the phone conversation with the patient.

Record phone contact screen 60 is used when a patient is contacted by the user or the home care provider or vice versa, and can be used to update the patient-specific information in the central database. For example, the record phone contact screen is used to input into the system the fact that the patient was contacted via telephone, when that contact took place, what the general complaint of the patient was (if any), and provides a field in which notes regarding that contact can be entered. In a preferred embodiment of the present invention, contract description field 61 includes a scroll down menu that lists common or categorized types of patient contacts, such as “device not functional”, “mask problem”, etc. The system can then generate report of all types of patient contacts, such as mask problems, for keeping track of such events. Of course, other fields can be provided in addition to or in place of fields 61 and 62 for memorializing information concerning a phone contact with a patient.

It should be noted that the record phone contact screen shown in FIG. 11 includes “edit” buttons. The record phone contact screen first displayed when selecting the “record phone contact” interaction from toolbar 44 need not include such buttons.

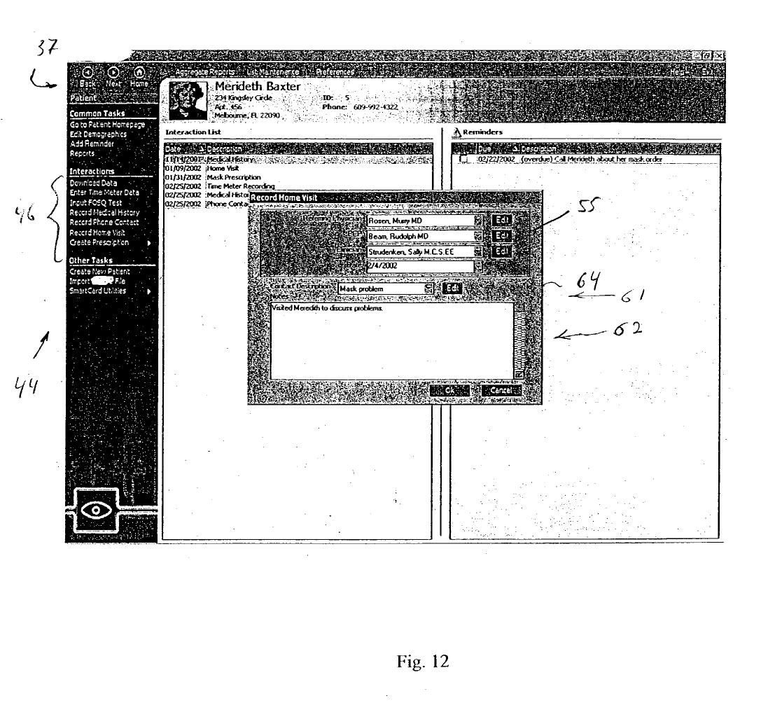

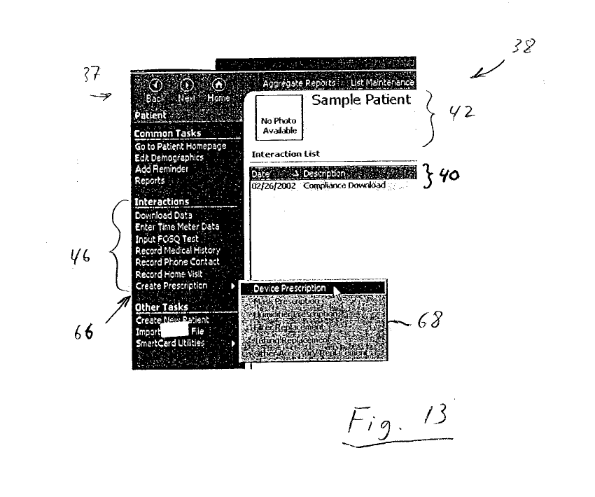

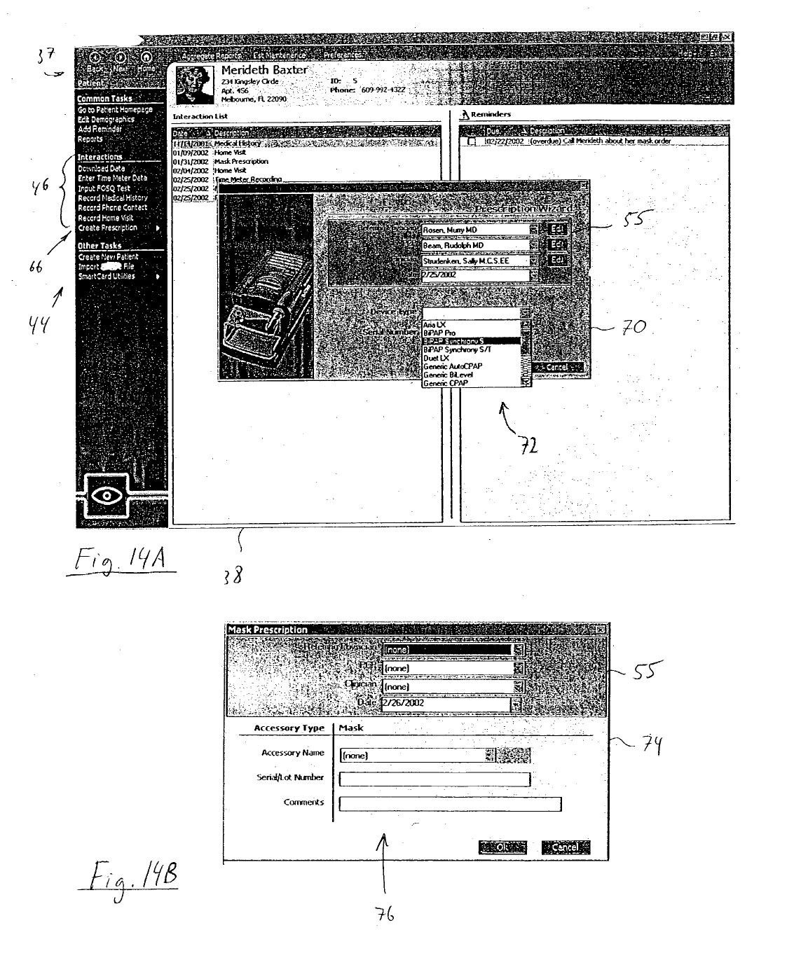

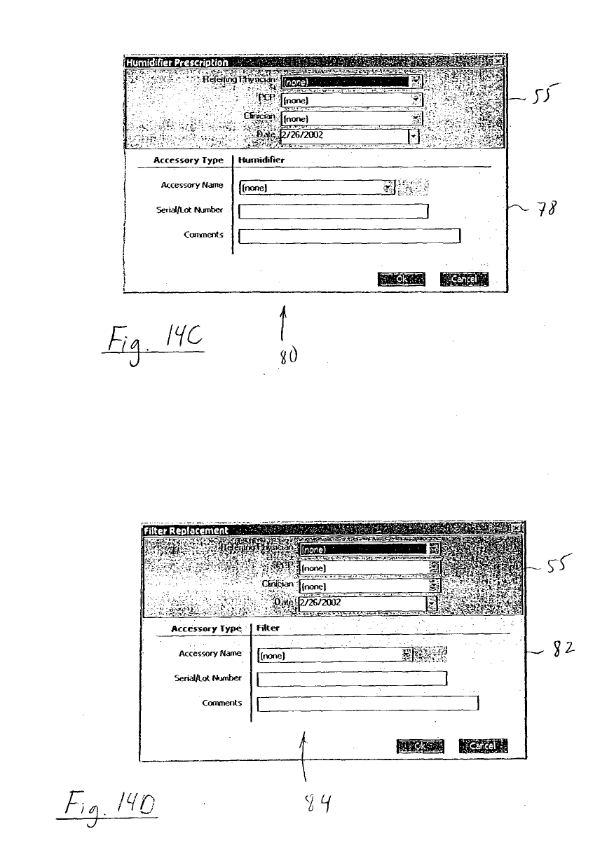

FIG. 12 illustrates a record home visit input screen 64 that is displayed when the user selects the “record home visit” item from interactions section 46 of toolbar 44. Record home visit screen 60 includes caregiver field 55 that includes the referring physician, the primary care provider, the clinician, and the date. Record home visit screen 64 also includes contact description field 61 and notes field 62. Like the phone contact form, the home contact form is used to update the patient-specific data in the central database. More specifically, the home visit information and phone contact information allow the user to monitor the amount and content of interactions taking place with the patients under the supervision of the healthcare provider. This is useful, for example, in monitoring those patients that require above normal supervision. It can be appreciated that record phone contact screen 60 and record home visit screen are quite similar. For this reason, the present invention contemplates that a single “patient contact” screen can be provided for any type of patient contact, with “type of contact” field being provided for indicating whether the contact was a home visit or a phone contact, for example.

It should also be noted that the record home visit screen shown in FIG. 12 includes “edit” buttons. The record home visit screen first displayed when selecting the “record home visit” interaction from toolbar 44 need not include such buttons.

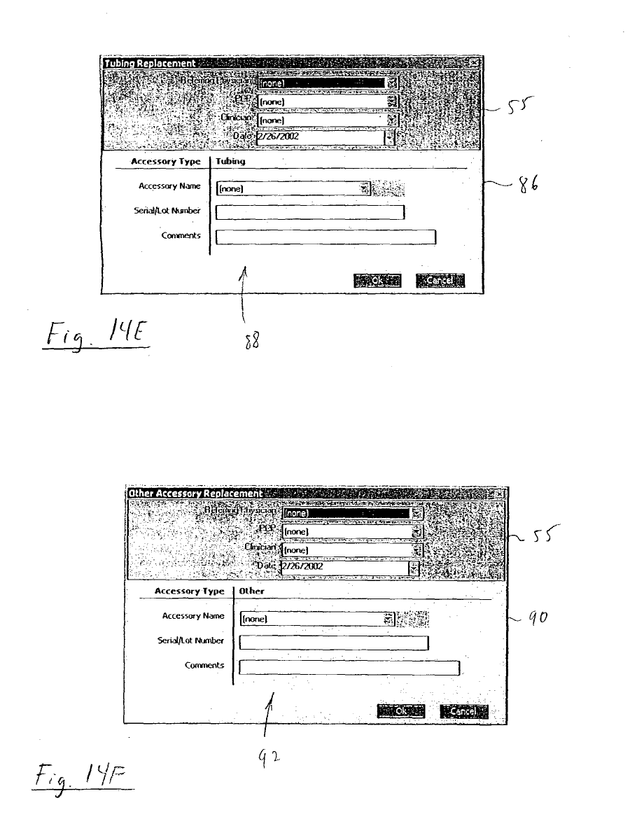

Interactions section 46 of tool bar 44 in patient home page 38 includes a “create prescription” sub-section 66. Accessing create prescription sub-section 66 provides the user with at least one choice, and preferably multiple choices, concerning the prescription for the patient. FIG. 13 illustrates a prescription pop-up box 68 that appears when the “create prescription” section is selected. In a preferred embodiment, box 68 provides the following prescription choices a device prescription, mask prescription, humidifier prescription, filter prescription, tubing replacement and other accessory replacement. Accessing these choices allows the user to create or change that prescription for the patient. Of course, other types of prescription information and corresponding prescription selections can be provided by the present invention and displayed as an option for selection in box 68 in addition to or in place of those shown in FIG. 13.

It should be noted that filters, humidifiers, masks, and tubing are common accessories used in a pressure support system. Each of these items have a limited life span and need periodic replacement. The schedule for replacement is often dictated by the reimbursement policy of the insurance provider. This replacement information is contained in the information management system of the present invention and used to generate reminders of when replacements of such components are due based on the time that these components have been used by a patient.

FIG. 14A illustrates a medical device information screen 70 that is displayed when the user selects the “device prescription” item from prescription pop-up box 68. Medical device information screen, like all screens associated with interaction section 46 includes caregiver field 55 that allows for the input of the referring physician, primary care provider, clinician, and date. Further, medical device information screen 70 includes a device type field 72 and a serial number field (not shown because it is obscured by the pull-down menu associated with the device type field) that allows for the device type and serial number to be entered, and, in an exemplary embodiment, includes a picture or photographic image of the device that will be prescribed. This allows the user to track the specifics of the device used by the patient, and cross-reference the device with performance results and other data. Of course, other information associated with the medical device can be provided in medical device information screen 70, such a part number, custom configuration, and other comments.

In a preferred embodiment of the present invention, medical device information screen 70 operates as a “wizard” guide that provides a step-by-step process for allowing the user to select the type of medical device corresponding to that prescribed to the patient by the physician or other caregiver. For example, device type field 72 can include a pull-down menu that lists all of the medical devices that are capable of being prescribed to a patient.

FIG. 14B illustrates a mask prescription screen 74 that is displayed when the user selects the “mask prescription” item from prescription pop-up box 68. Mask prescription screen 74 includes caregiver field 55 that allows the input of the referring physician, the primary care provider, the clinician, and the date. Mask prescription screen 74 also includes a mask description field 76 that identifies the mask or other patient interface device prescribed for or otherwise used by the user, such as by mask name, serial, lot number, part number, type, etc. Preferably, the mask description field includes a pull-down menu that allows the user to select a mask prescribed to the patient from a list available masks. As noted above, the information management system of the present invention is programmed to know the replacement date for any given mask. As a result, when a mask type and data are set using fields 55 and 74 in mask prescription screen 74, the system can automatically generate a reminder in reminder field 36 or 36′, as well as on any reports associated with the patient or other reminder reports, reminding the user when a replacement mask should be provided to the patient.

FIG. 14C illustrates a humidifier prescription screen 78 that is displayed when the user selects the “humidifier prescription” item from prescription pop-up box 68.

Humidifier prescription screen 78 includes caregiver field 55 and a humidifier description field 80 that identifies the humidifier device prescribed for or otherwise used by the user, such as by humidifier's name, serial, lot number, part number, etc. Preferably, the humidifier description field includes a pull-down menu that allows the user to select a humidifier prescribed to the patient from a list available humidifiers. As noted above, the information management system of the present invention is programmed to know the replacement date for any given humidifier, if any. As a result, when a humidifier type and data are set using fields 55 and 80 in humidifier prescription screen 78, the system can automatically generate a reminder in reminder field 36 or 36′, as well as on any reports associated with the patient or other reminder reports, reminding the user when a replacement humidifier should be provided to the user.

FIG. 14D illustrates a filter prescription screen 82 that is displayed when the user selects the “filter replacement” item from prescription pop-up box 68. Filter prescription screen 82 includes caregiver field 55 and a filter description field 84 that identifies the filter prescribed for or otherwise used by the user, such as by filter name, serial, lot number, part number, etc. Preferably, the filter description field includes a pull-down menu that allows the user to select a filter prescribed to the patient from a list available filters. As noted above, the information management system of the present invention is programmed to know the replacement date for any given filter. As a result, when a filter type and data are set using fields 55 and 84 in filter prescription screen 82, the system can automatically generate a reminder in reminder field 36 or 36′, as well as on any reports associated with the patient or other reminder reports, reminding the user when a replacement filter should be provided to the user.

FIG. 14E illustrates a tubing prescription screen 86 that is displayed when the user selects the “tubing replacement” item from prescription pop-up box 68. Tubing prescription screen 86 includes caregiver field 55 and a tubing description field 88 that identifies the tubing prescribed for or otherwise used by the user, such as by tubing name, serial, lot number, part number, etc. Preferably, the tubing description field includes a pull-down menu that allows the user to select a tubing prescribed to the patient from a list available tubings. As noted above, the information management system of the present invention is programmed to know the replacement date for any given tubing, if any. As a result, when a tubing type and data are set using fields 55 and 88 in tubing prescription screen 86, the system can automatically generate a reminder in reminder field 36 or 36′, as well as on any reports associated with the patient or other reminder reports, reminding the user when a replacement tubing should be provided to the user.

FIG. 14F illustrates an accessory prescription screen 90 that is displayed when the user selects the “other accessory replacement” item from prescription pop-up box 68. Other accessory prescription screen 90 includes caregiver field 55 and an accessory description field 92 that identifies other accessories prescribed for or otherwise used by the user, such as by accessory name, serial, lot number, part number, etc. Preferably, the accessory description field includes a pull-down menu that allows the user to select an accessory prescribed to the patient from a list available accessories. As noted above, the information management system of the present invention is programmed to know the replacement date for any given accessory, if any. As a result, when an accessory type and data are set using fields 55 and 92 in accessory prescription screen 90, the system can automatically generate a reminder in reminder field 36 or 36′, as well as on any reports associated with the patient or other reminder reports, reminding the user when a replacement for that accessory should be provided to the user.

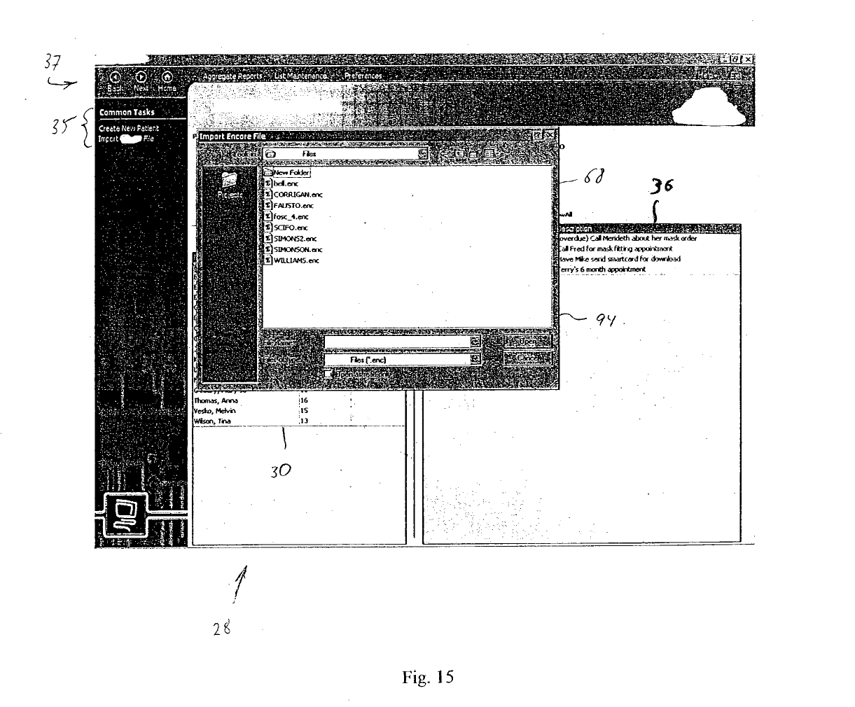

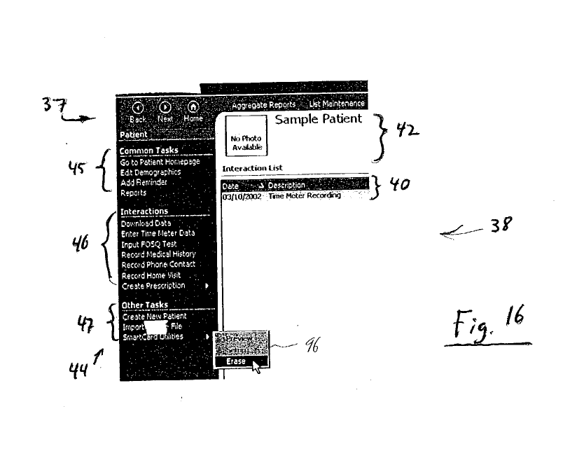

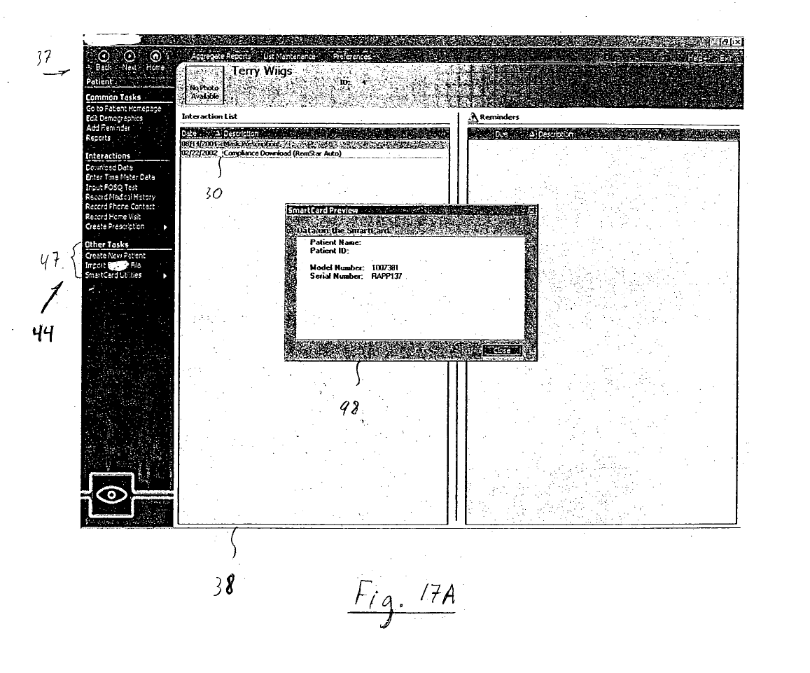

As noted above, home page 28 includes a “common tasks” toolbar 35 that includes an “import file” option. FIG. 15 illustrates an import file select screen 94 that is displayed when the import file option in toolbar 35 is selected from home page 28. Import file select screen 94 allows the user to input data and other previous versions from other information management systems or files, such as “older” medical information management systems. In this manner, the user does not have to recreate all of the data from “scratch,” and may simply import the data into the data fields in the central database. This is especially useful as newer revisions of the information management system are generated and the data from an older system needs to be retained in the newer system.

As shown, for example, in FIG. 3, other tasks section 47 on toolbar 44 of patient home page 38 includes “create new patient” and “import file” selections. The selections provide the same functions described above with respect to the “create new patient” and “import file” selections on common tasks toolbar 35 of home page 28. In addition, other tasks section 47 of toolbar 44 includes a “smartcard utilities” selection. This selection is used to perform various tasks related to the use of a smartcard as a data transfer medium for gathering information, such as compliance data, from a medical device, such as a pressure support system. It should be understood that other data transfer mediums are contemplated by the present invention. In which case, the functions associated with using these other transfer media can be incorporated into toolbar 44 or into other fields of the patient home page 38 or main home page 28. Of course, the utilities associated with a smartcard or the data storage medium can only be performed if the smartcard is in communication with the information management system of the present invention. An example of the use of a “Smartcard” as a temporary storage medium for interfacing with a pressure support system is described in published PCT application no. WO 01/32069, the contents of which are incorporated herein by reference.

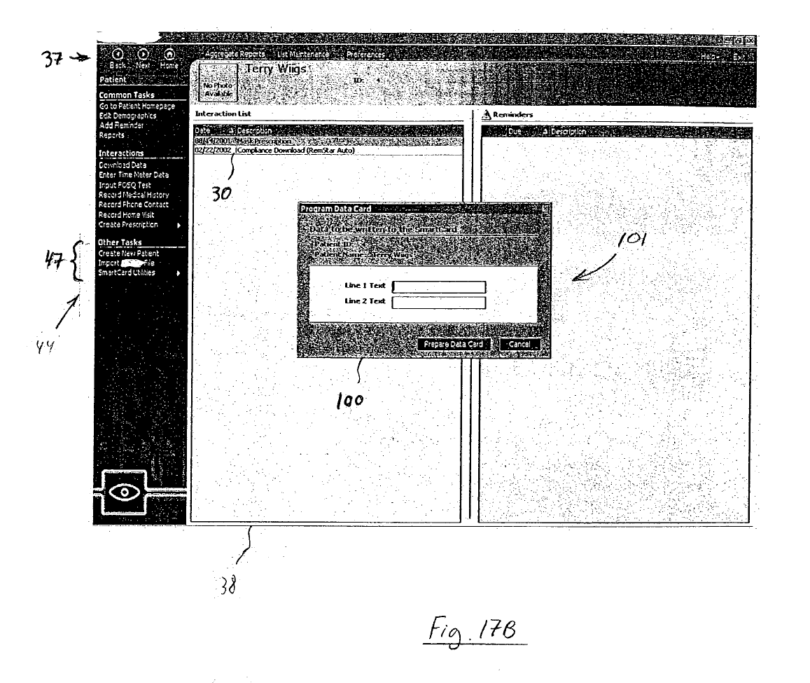

When the “smartcard utilities” selection on other tasks section 47 is selected, a smartcard utilities box 96 appears as shown, for example, in FIG. 16. This box provides a number of options for various functions that can be preformed with respect to the smartcard, assuming, of course, that the smartcard is in communication with the medical information management system. In the exemplary embodiment shown in FIG. 16, the following three options are presented: “preview”, “setup”, and “erase”. It is to be understood that this list of options is not limited to those presented in FIG. 16. On the contrary, the present invention contemplates that any number of options regarding the smartcard and be presented.

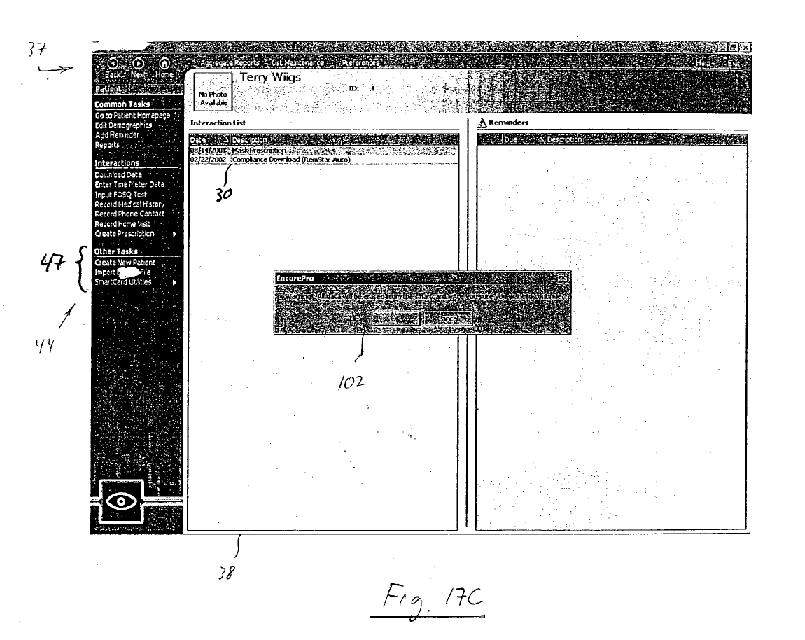

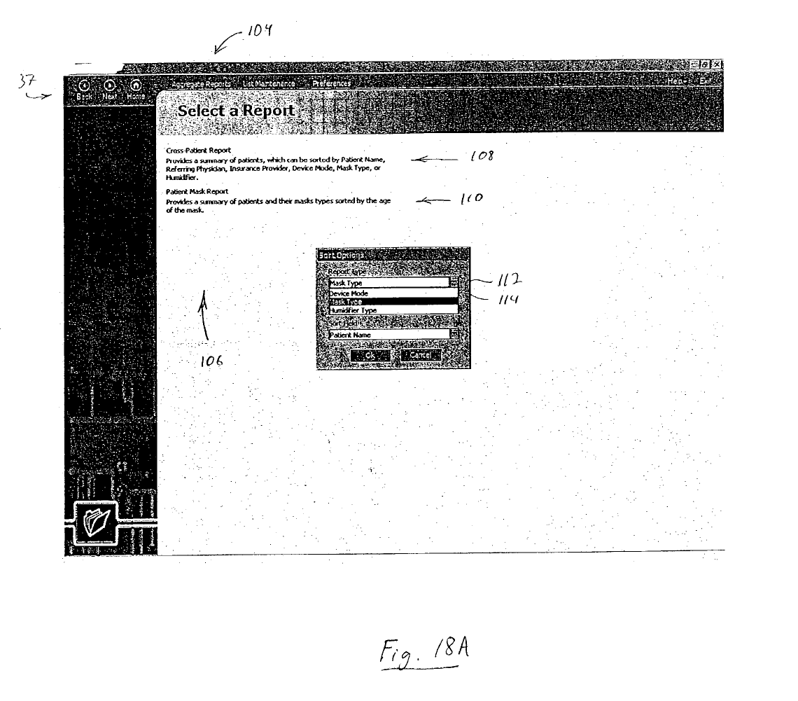

FIGS. 17A-17C illustrate various screens that are displayed as utility subroutines are selected from smartcard utilities box 96. More specifically, FIG. 17A illustrates a smartcard preview screen 98 that is displayed when the “preview” selection in box 96 is selected. In the illustrated exemplary embodiment, preview screen 98 includes a main field that displays any information regarding the data on the smartcard, such as the patient information for the patient to whom the smartcard is assigned and the prescription information associated with that patient.

This information can include, but is not limited to, the (1) patient name, (2) patient ID, (3) model name, number and serial for the medical device being used by the patient, and (4) the prescription details, such as the (a) CPAP pressure (or IPAP and EPAP pressures for a bi-level system), (b) ramp shape (which is the shape of the pressure ramp provided to the patient), (c) ramp time (which is duration of the gradual pressure or ramp pressure increase), (d) auto-on enabled or disabled, and (e) auto-off enabled or disabled. The ramp feature is a gradual increase in pressure from a relatively low pressure to the prescription pressure to enable to the patient to fall asleep at a relatively low pressure while the system increases the pressure automatically to the prescription pressure. Auto-on and auto-off are features that allow the pressure support system to turn on or off automatically depending on whether the patient is breathing into the pressure support system. It is to be understood that any other information stored on the smartcard can be provided in preview screen 98.

FIG. 17B illustrates a smartcard setup or program screen 100 that is displayed when the “setup” selection in box 96 is selected. In the illustrated exemplary embodiment, setup screen 100 includes a main field that displays information to setup or program the smartcard for use with a patient. This is necessary because it is preferable that each smartcard or other data storage device be uniquely associated with a patient or with the medical device, such as a pressure support system, being used by a patient. Thus, each smartcard must be “assigned” to a patient or a medical device by providing a unique identification associated with the patient or medical device prescribed to that patient. This is accomplished in setup screen 100 by providing at least one field 101 in which data is provided identifying the smartcard. This data is then written onto the smartcard for display each time the smartcard is read, so that later readers of the smartcard can identify the patient or the medical device associated with that smartcard.

FIG. 17C illustrates a smartcard erase screen 102 that is displayed when the “erase” selection in box 96 is selected. In the illustrated exemplary embodiment, erase screen 102 includes a warning message that provides the user with a warning that all data stored on the smartcard will be erased if the erase process continues. Preferably, the warning message includes a question confirming whether or not user intends to continue with the smartcard erase process. This multi-step process that must be executed before the smartcard is erased helps prevent inadvertent erasure of the data storage medium.

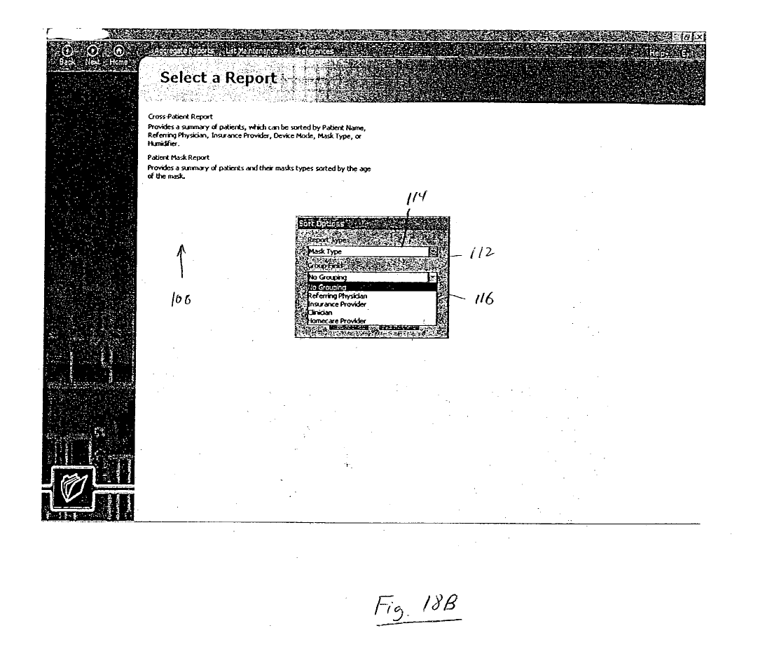

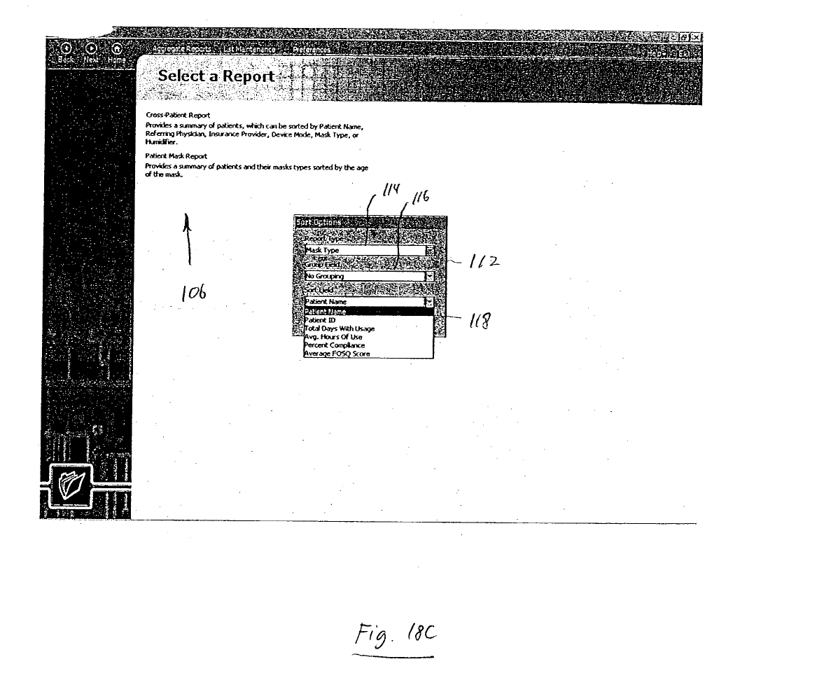

FIGS. 18A-19B illustrate screens for creating and presenting aggregate reports, which are reports that display information about the entire patient database, rather than information about a single patient, as is the case with the reports generated from the reports section in “common tasks” section 45 of toolbar 44 in patient home page 38 (see, e.g., FIG. 6). The aggregate reports are accessed by selecting an “aggregate reports” option 104 from navigation bar 37. This causes the main display to list the aggregate reports available to the user in a display field generally indicated at 106. the “These aggregate-type reports demonstrate the common-field functionality of the central database and method and system.

In this illustrated exemplary embodiment, the user may select a cross-patient report selection 108 and a patient mask report selection 110 from display field 106. A cross-patient report lists common information for a number of patient. For example, a cross-patient report can list the usage, compliance, FOSQ, prescription, physician and insurance information for all patients in the database. A patient mask report is a summary of patients and their mask types, preferably sorted according to some criteria, such as the age of the mask. Although not illustrated in display field 106, the present invention also contemplates providing an equipment replacement report that lists the equipment for all patients in the database that are due to be replaced in a given time frame, such as each month. An example of such an equipment replacement report is shown in FIG. 19B.

Upon selecting cross-patient report selection 108 from data field 106, a sort options screen 112 is presented. This screen allows the user to choose how the cross-patient data is to be sorted and presented. More specifically, the sort options screen allows the user to determine what type of data is to be included in the report, how that data is grouped in the report, and how the data will be sorted within the group. FIGS. 18A-18C show how the sort options screen is used to make these selections.

Sort options screen 112 includes a “report type” field 114 that defines the way in which the report is summarized. In the exemplary embodiment shown in FIG. 18A, the report types that can be selected include “device mode”, “mask type”, and “humidifier type”. Sort options screen 112 also includes a “group field” portion 16 that defines the way in which the report data will be grouped within the report. In the exemplary embodiment shown in FIG. 18B, the groups that can be selected include “no grouping”, “referring physician”, “insurance provider”, and “homecare provider”. Finally, sort options screen 112 includes a “sort field” portion 118 that defines the way in which the report data will be sorted within each group. In the exemplary embodiment shown in FIG. 18C, the sort options include sorting by “patient name”, “patient ID”, “total days with usage”, “average hours of use”, “percent compliance”, and “average FOSQ score”. After the user has selected the report type, the grouping criterion, and the sort criterion, the system outputs a report, as viewed by a report viewer. FIG. 19A, which is discussed below, illustrates the report viewer from which the cross-patient aggregate report can be viewed, printed, or exported. FIGS. 25A-25B and 26A-26C, which are discussed in detail below, show examples of such reports.

FIG. 19A illustrates a patient mask report 120 that is generated in a reports viewer window 122 when the patient mask report selection 110 in display field 106 is chosen. Patient mask report 120 includes the following columns: “patient name”, “phone number,” “average hours of use”, “percent compliance”, “insurance provider”, “mask type”, “mask age (in days)”, and “referring physician's name”.

FIG. 19B illustrates an equipment replacement report 121 that is similar to patient mask report 120 except that it is inclusive of a variety of equipment, such as masks, medical devices (CPAP, Bilevel, Auto-titration, etc.), tubing, filters, etc. In the illustrated exemplary embodiment, equipment replacement report 121 indicates the time period over which the report pertains, such as the month, and the equipment that is available to be replaced during that time period. More specifically, the report includes the following columns: “patent name”, “patient ID”, “patient phone number”, “delivery date”, and “eligible date”, which is the specific date the equipment is eligible for replacement. As noted above, the replacement date can be set based on any one of a variety of criteria, including but not limited to the reimbursement schedule provided by the patient's medical insurance provider. As shown in FIG. 19B, the equipment replacement report also preferably includes a summary 123 of the equipment that is eligible for replacement during the specified time period. In an exemplary embodiment of the present invention, this summary lists the equipment in one column and the number units of that type that are eligible for replacement in an adjacent column.

It can be appreciated that other columns providing other information can be presented in place of or in addition to those shown in FIG. 19A or 19B. Reports view window 122 includes a toolbar 124 with various buttons for viewing, printing, and exporting the data being viewed. The report viewer window allows the user to set up the printer, print, copy, find, view a single page, view multiple pages, zoom in, zoom out, magnify, move to the previous page, move to the next page, move to a specific page, move backward, move forward, export to HTML, export to PDF, export to TIFF and exit the viewer. Of course, this list is not intended to be exhaustive of all the functions that can be preformed.

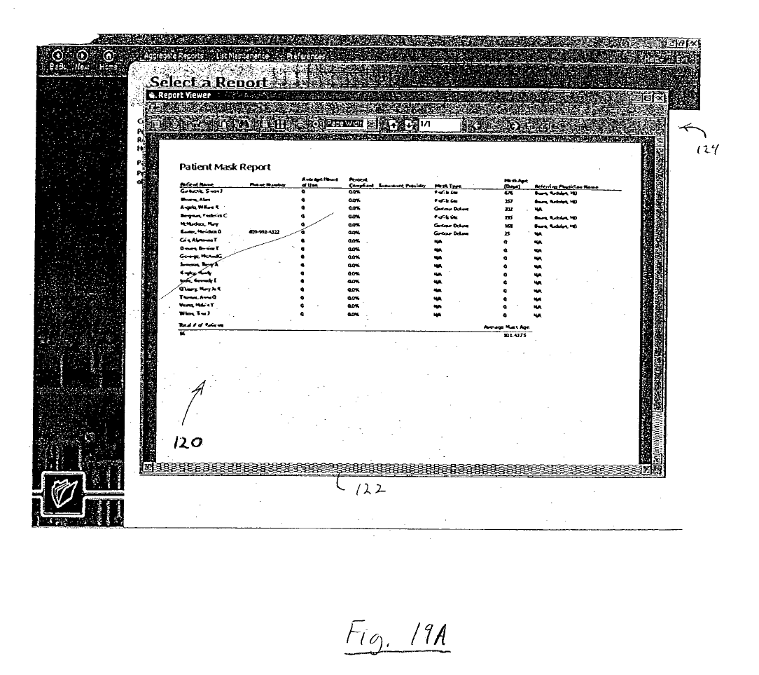

It can be appreciated from the forgoing description of the present invention that there are numerous lists of data that are provided in drop-down menus. For example, a listing of different surgical procedures is available at a pop-down menu in medical information fields 59 of medical history entry form screen 53. The present invention contemplates maintaining and configuring these lists via a “list maintenance” option in navigation field 37. FIG. 20 illustrates a list maintenance screen 126 that is displayed when the list maintenance” option in navigation field 37.

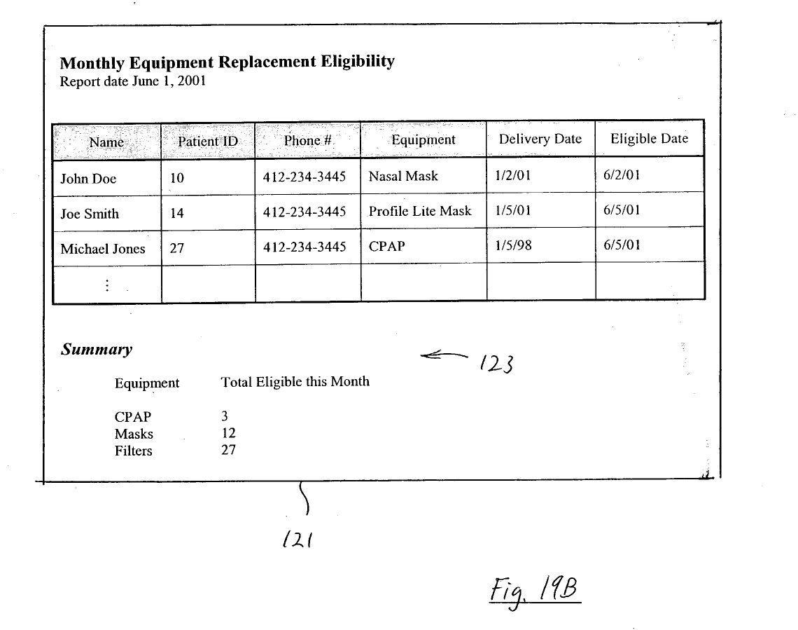

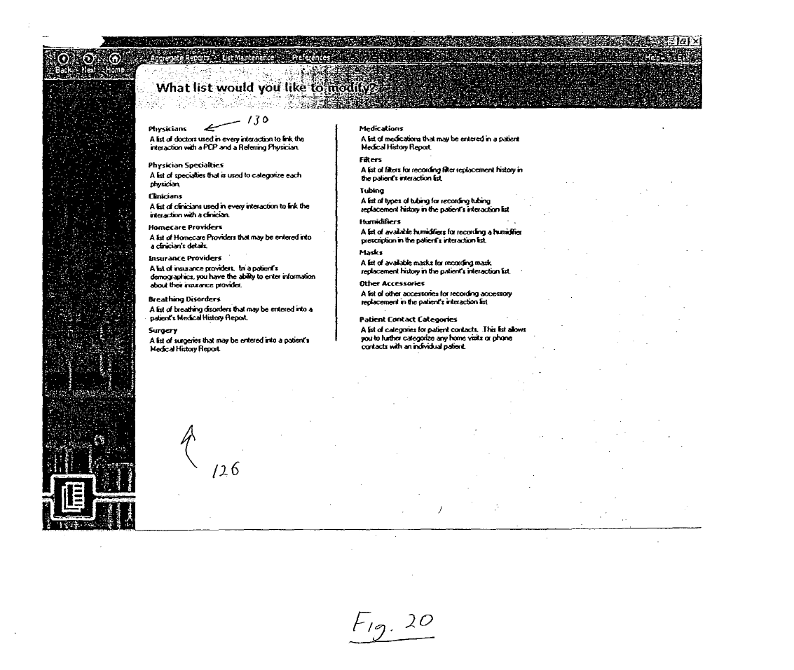

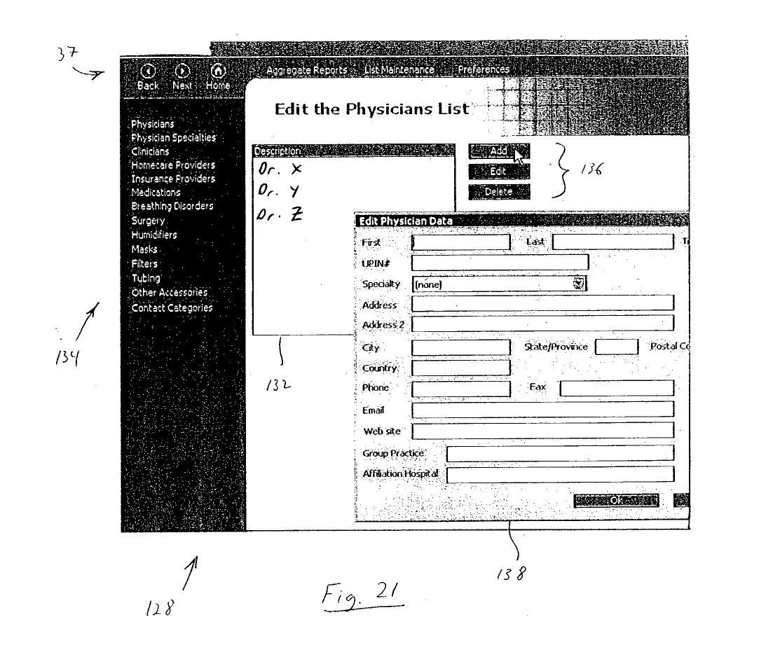

FIG. 21 illustrates an example of a screen 128 that is displayed when one of the items in list maintenance screen 126 is selected. More specifically, screen 128 corresponds to that displayed when a “Physicians” option 130 in list maintenance screen 126 is selected. Screen 128 includes a description field 132 that preferably lists the entries associated with the selection, such as all of the physicians that can be selected. Screen 128 also includes a toolbar 134 for accessing other lists available in the information management system. Finally, screen 128 includes an editing field 136 that allows the user to modify the entries associated with this list. In the illustrated embodiment, the user can add, edit, or delete entries associated with this selection. If an entry is to be added, the user clicks on the “add” button and a pop-up screen 138 appears. In this embodiment, screen 138 includes numerous fields for recording a variety of information associated with a physician. Editing an existing entry is accomplished, for example, by selecting an existing entry from field 132 and clicking on the “edit” button in field 136. A pop-up screen similar to screen 138 appears in which the user can edit the data. Deleting an entry is performed in a similar manner.

The lists available for input/editing from list maintenance screen 126, include the following: doctors used in every interaction; physician specialties; clinicians used in every interaction; home care providers; insurance providers; breathing disorders; surgeries; medications; filters for recording filter replacement history; tubing types for recording tubing replacement history; humidifiers for recording a humidifier prescription; masks for recording mask replacement history; other accessories; and categories for patient contacts. It is to be understood that this is not intended to be an exhaustive or exclusive listing of the lists available for use in the present invention. The present invention contemplates that this lists can be viewed, sent, formatted and otherwise acted upon in any conventional data processing technique.

Navigation field 37 in home page 28 includes a “preference” selection. FIG. 22 illustrates a preferences screen 140 that is displayed when this preferences option is selected. Preferences screen 140 is used to configure the user's preferences. More specifically, this screen includes a facility information area 142 that allows for the input, modification and deletion of facility name, address, city, state, postal code, modem phone number, and logo file. The present invention contemplates that the facility information data is printed in the header area of the reports generated using this system. Preferences screen 140 also includes an “other settings” area 144 that allows for setting a variety of features associated with the present invention, such as a minimum therapy time, communications port, and database name. The minimum therapy time is the amount of time during a 24-hour period that the patient must use the device to be considered compliant. This number is used on compliance reports to highlight non-compliant days and display compliance statistics. The communications port and database name are settings use to configure the system to communicate with an external device, i.e., a device not resident on the computing station running the information management system of the present invention, such as a smartcard reader/writer. For example, this section is used to connect and adapt cable communications between the external device and the system running the information management system of the present invention.

For individual patient reports, patient information is displayed on the report. The reports fall into three categories: (1) aggregate reports, which display information reflecting the entire patient database; (2) general reports, which contain patient information on compliance, FOSQ scores and personal data; and (3) interaction reports, which provide graphic and tabular displays of information for specific interactions with the patient.

A powerful feature of the present invention is the ability to view, save, print and send reports pertaining to the information contained in the central database. The reports available using the information management system of the present invention fall into three categories: (1) aggregate reports, which display information reflecting the entire patient database; (2) general reports, which contain patient information on compliance, FOSQ scores, and personal data; and (3) interaction reports, which provide graphic and tabular displays of information for specific interactions with the patient. Aggregate reports are accessed via “aggregate reports” option 104 from navigation bar 37 as discussed above with respect to FIGS. 18A-18C. General reports are accessed by selecting the “reports” item listed in common tasks section 45 of toolbar 45 from patient home page 38 to display reports screen 52 as discussed above with respect to FIG. 6. An interaction report is accessed by selecting an interaction for the patient homepage for printing or viewing. This is accomplished, for example, by double-clicking on an interaction or right-clicking on an interaction and selecting print or view from the options presented.

FIGS. 23A-23E is an example of an interaction report for a single patient. More specifically, FIGS. 23A-23E illustrate a compliance report that is generated by selecting a compliance type interaction from the patient's homepage. Each page of the report includes a heading that is set using the “preferences” option from navigation bar 37. The opening page of the report (FIG. 23A) includes a section 146 containing patient information and a section 148 containing compliance information presented in chard form. Page 2 of the report (FIG. 23B) is a bar graph that show daily usage of the medical device, which in this illustrated embodiment is an auto-titration pressure support system. It should be noted that the “REMstar Auto” is the brand name of a conventional auto-titration pressure support system. Page 3 (FIG. 23C) provides charts and summaries of the pressure delivered by the pressure support system, a non-responsive apnea/hypopnea index, and obstructive apnea index, a hypopnea index, a flow limitation index, a snore index and a leakage of gas from the system, over the monitored period. Page 4 (FIG. 23D) provides charts of the pressure delivered by the pressures support system, flags that are raised when a monitored parameter exceeds a predetermined threshold, and the leakage of gas from the system. It should be noted that this page provides data for a single therapy session. Page 4 also includes summaries of the charts and a table of the data being monitored during that therapy session. Page 5 (FIG. 23E) provides summaries of the data collected for the patient in table, chart, and statistical form.

There may be instances where a user may wish to exclude days from a compliance report. For example, a patient using a CPAP system may become ill and be admitted to a hospital for a period of days. During this period, the patient's healthcare or medical equipment provider or supervisor may not want to count these days in which the patient was in the hospital, not using the CPAP treatment, against the patient as an indication of lack of compliance. This can be accomplished in the monitoring system of the present invention in a variety of ways. For example, the days of excused compliance monitoring can be input into the system an excluded from any compliance reports and not used in calculating overall compliance during a given period of days under review. Rather than completely remove these excused compliance days, they can be highlighted in the compliance reports as being excused. For example, the days of excused compliance can be highlighted in the daily compliance report shown in FIG. 23B using a unique color, so that the reader easily understands that these days are intentionally excused from the patient's overall compliance monitoring.

FIGS. 24A and 24B is an example of a general report for a single patient. More specifically, these figures show a FOSQ summary that is generated by selecting a “FOSQ trend” report from reports screen 52 on the patient's homepage. The first page of the FOSQ summary includes section 146 containing patient information. The remainder of this general report includes a trend chart 150 and tables showing the results of each of the FOSQ tests taken by the patient.

FIGS. 25A-26B are examples of “cross-patient” reports that display data in a desired format for multiple patients. For example, FIGS. 25A and 25B is a report that lists all of the patients of a healthcare provider that are using an auto-titration, bi-level, and CPAP pressure support system. For each type or mode of pressure support, the reports lists the patient name, patient ID, total days the device was used, average hours of use and the FOSQ scores for the patients using such system. This information is useful, for example, in tracking patient compliance and in monitoring the effectiveness of the different types of therapy. This is accomplished, for example, by displaying the average hours of use and the average FOSQ scores for each patient using each type of pressure support system and by providing a graph, such as that shown in FIG. 25B, showing average use for each type of pressure support device.

FIGS. 26A and 26B is a cross-patient report that lists all of the patients of a healthcare provider that are using different types of masks, i.e., a “Comfort Select”, “ComfortClassic”, and “Profile Lite”. For each type of mask, the reports also lists the patient name, patient ID, total days the device was used, average hours of use and the FOSQ scores for the patients using such system. This information is useful, for example, in tracking patient compliance and in monitoring the effectiveness of each of the different types of mask.

The following is listing of the reports that can be generated by the present invention: compliance download interaction reports, compliance/therapy download interaction reports, FOSQ summary interaction reports, FOSQ trend reports, home visit interaction reports, medical history interaction reports, multiple download compliance reports, patient demographic reports, patient mask reports, phone contact interaction reports, prescription change interaction reports, and time meter data interaction reports. The patient mask reports may also show how old each patient's mask is. Compliance and other patient information may be displayed to allow the viewer to quickly contact the patient or their physician. The patient demographics report displays all the demographic and medical information about the patient, as well as all the interactions that have occurred with the patient. The FOSQ reports show the results of a quality of life test that the patient may take. The patient's subscores and trends are also displayed. The compliance download interaction reports display compliance data from all of the downloads that have occurred for a particular patient. Further, interaction reports display the details of a patient interaction and they also display device compliance and therapy reports, which are based on data downloaded from the device in various manners.

The present invention further contemplates that the information management system includes a “help file” as shown in the right side of navigation field 37. The help file provides the user with assistance or help in using the system. In an exemplary embodiment of the present invention, this “help file” includes information about the manufacturer, the system home page or home screen, a glossary defining terms and acronyms used through the information management system, a patient identification description, preference entry, equipment setup, “how to” pages, interactions, modem manager, patient information, physician and clinician information, reminders, reports and temporary storage medium utilities.

The “How to” or “How Do I” section of the help menu preferably includes a discussion of how to complete a FOSQ test, how to complete an FOSQ test using a manufacturer's device, how to create a patient record, how to create an interaction, how to create or change a prescription, how to delete a patient record, how to delete an interaction, how to download from a manufacturer's device, how to download from a temporary storage medium device, how to edit an interaction, how to enter patient data, how to maintain database lists, how to open a patient record, how to print an interaction report, how to run a report, how to search for a patient, how to use reminders, how to use the modem manager, and how to view an interaction report.

The present invention further contemplates that the help menu discusses how to do the following functions:

(1) create a new patient record by using a new patient command or by importing a new patient from an existing file;

(2) delete a patient record or interaction;

(3) move data from a device or a temporary storage medium into the system, and eventually, the central database;

(4) edit an interaction with a patient;

(5) enter patient data using downloading;

(6) directly record interactions;

(7) import data from old files;

(8) edit demographics;

(9) customize the available choices in drop-down menus using the “list maintenance”; and

(10) open a patient record from the home screen (FIG. 2).

All of these function are accomplished by the information management system using conventional computer implemented techniques and short cuts, such as pull down menus, active links, pop-up boxes, drag-and-drop operations, keyboard shortcuts, mouse pad button shortcuts, etc.

The help menu further discusses how to generate, view, print and save different reports on patient data. For individual patient reports, patient information is displayed on the report. The reports fall into three categories: (1) aggregate reports, which display information reflecting the entire patient database; (2) general reports, which contain patient information on compliance, FOSQ scores and personal data; and (3) interaction reports, which provide graphic and tabular displays of information for specific interactions with the patient.

The information system of the present invention also includes a modem manager controls how the system receives, manages and inputs device direct calls. In an exemplary embodiment of the present invention, when a device direct call is received, the modem manager verifies the patient identification number, and then the compliance of therapy data is downloaded and stored in the central database. A reminder is created in the system, and the downloaded data is erased from the device. Next, the call is terminated. If the patient identification of the device is not found in the central database, the modem manager generates an error in the log file and the data will not be downloaded. The modem manager also allows the user to view log files, configure serial ports, and has its own individual help file.

The “Reports” area of the help section discusses the content of specific reports available with the system, including aggregate reports, compliance download interaction reports, compliance/therapy download interaction reports, cross-patient reports, FOSQ summary interaction reports, FOSQ trend reports, home visit interaction reports, medical history interaction reports, multiple download compliance reports, patient demographic reports, patient mask reports, phone contact interaction reports, prescription change interaction reports, and time meter data interaction reports. See FIGS. 29(75)-29(85). The multi-patient reports display patient compliance versus the mode of their device, the mask type they use or whether they have a humidifier attached to their device. Options included in this report are a customizable range of the data to report on, how the data should be grouped, and, further, how the data should be sorted. The patient mask reports may show how old each patient's mask is. Compliance and other patient information may be displayed to allow the viewer to quickly contact the patient or their physician. The patient demographics report displays all the demographic and medical information about the patient, as well as all the interactions that have occurred with the patient. The FOSQ reports show the results of a quality of life test that the patient may take. The patient's subscores and trends are also displayed. The compliance download interaction reports display compliance data from all of the downloads that have occurred for a particular patient. Further, interaction reports display the details of a patient interaction and they also display device compliance and therapy reports, which are based on data downloaded from the device in various manners.

Although not shown in the figures, the present invention contemplates providing an advertising field in one or more of the screen shown to the user. The advertising field can contain advertisements or other information that may be relevant to the user of the system. For example, the present invention contemplates that a medical device manufacture will use such an advertising field to provide advertising or other promotional information to the healthcare provider using the information management system of the present invention.

The present invention provides a method for managing medical information and a medical information management system, which is capable of monitoring the device or equipment used by a patient and to cross-correlate the device or equipment used by a number of patients, with the compliance or effectiveness of such use. The present method and system has a dynamic linking ability between like fields for different patients, which provides the ability to present useful multi-patient data for any particular area of interest. The present method and system allows the user, typically a home care provider, to search, group, sort and present data and reports summarizing and formatting areas of interest to the home care provider. The method and system is equally useful for a primary care provider, an insurer, a device/equipment manufacturer, a physician, a clinician and other users. In addition, the present method and system effectively tracks referrals, manages interactions, manages reminders and creates useful visual presentation of data.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

What is claimed is:

1. A computer-implemented method for managing medical information, comprising the steps of:
providing a database of information for a plurality of patients, wherein a plurality of disparate data fields containing data are provided for each patient in the database;
selecting a sort criterion for organizing at least a portion of the plurality of disparate data fields for multiple patients according to the sort criterion;
formatting the organized portion of the plurality of disparate data fields in a presentable report; and
presenting the report to a user.

2. The method of claim 1, further comprising the step of grouping at least a portion of the plurality of disparate data fields into at least one set.

3. The method of claim 1, wherein the data in the plurality of disparate data fields corresponds to at least one of patient name, a patient address, a patient identification number, patient contact information, patient social security number, patient date of birth, patient gender, patient marital status, patient ethnic category, patient occupation, patient disorder data, patient surgical data, patient medication, insurance provider, insurance policy number, insurance group number, policy holder name, policy holder relationship, comments, patient photographic image, referring physician data, primary care provider data, home care provider data, clinician data, contact date, contact time, contact name, contact information, home visit date, recommended contact date, recommended device repair date, recommended device maintenance date, device type, device characteristics, device serial number, device prescription, prescription compliance data, device compliance data, compliance data, device usage dates, device usage information, session information, device physical settings, testing criteria, test inputs, testing results, equipment data, equipment replacement data, equipment maintenance data, facility data, therapy time, electronic communication data, database identification, file data, device/equipment images and patient specific data.

4. The method of claim 3, wherein the patient specific data corresponds to at least one of bed time, average hours of sleep, height, weight, neck circumference, Epworth sleepiness scale, blood pressure, diagnostic respiratory disturbance index, therapeutic respiratory disturbance index, minimum oxygen saturation, body mass index, and sleep facility name.

5. The method of claim 3, wherein at least one of the device and the equipment is a ventilator, a sleep apnea device, a pressure delivery system, an oximeter, a ventilatory support system, an oxygen concentrator, a pressure support device, a mask, a filter, a humidifier and tubing.

5. The method of claim 1, wherein the report is in the form of at least one of a list, a chart, a diagram and a graph.

6. The method of claim 1, further comprising entering data to the database using a screen that includes at least one of (a) a field for specifying a type of medical device used by such a patient and (b) a field for specifying a healthcare provider or health insurance provider for such a patient.

7. The method of claim 1, further comprising the steps of:
creating the database on a computing system;
transmitting the data to the computing system; and
entering at least a portion of the data into a predetermined one of the plurality of disparate data fields.

8. The method of claim 7, wherein transmitting the data is performed using a telecommunications data link or a temporary storage medium.

9. The method of claim 1, wherein the database comprises relational tables associating the plurality of disparate data fields with one another.

10. The method of claim 1, further comprising displaying data associated with an individual patient on a patient home page that includes a patient display field displaying patient identifying information and a reminder field displaying information pertaining to an action to be taken for such a patient.

11. A computer-implemented method for managing medical information, comprising the steps of:
providing a database of information for a plurality of patients, wherein a plurality of disparate data fields containing data are provided for each patient in the database;
selecting at least one of the plurality of disparate data fields;
providing a data field threshold value for the selected data field;
comparing the selected data field data with the data field threshold value; and
presenting a signal to a user responsive to the selected data field data reaching the data field threshold value.

12. The method of claim 11, wherein the data field threshold value is set by a user.

13. The method of claim 11, wherein the signal is at least one of an audible alarm and a visual display.

14. The method of claim 11, wherein the signal is a visual display and includes a message.

15. The method of claim 14, wherein the message is user-defined.

16. The method of claim 14, wherein data associated with an individual patient is displayed on a patient home page that includes a patient display field displaying patient identifying information and a reminder field displaying the message.

17. The method of claim 11, wherein the data in the plurality of disparate data fields corresponds to at least one of a patient name, a patient address, a patient identification number, patient contact information, patient social security number, patient date of birth, patient gender, patient marital status, patient ethnic category, patient occupation, patient disorder data, patient surgical data, patient medication, insurance provider, insurance policy number, insurance group number, policy holder name, policy holder relationship, comments, patient photographic image, referring physician data, primary care provider data, home care provider data, clinician data, contact date, contact time, contact name, contact information, home visit date, recommended contact date, recommended device repair date, recommended device maintenance date, device type, device characteristics, device serial number, device prescription, prescription compliance data, device compliance data, compliance data, device usage dates, device usage information, session information, device physical settings, testing criteria, test inputs, testing results, equipment data, equipment replacement data, equipment maintenance data, facility data, therapy time, electronic communication data, database identification, file data, device/equipment images and patient specific data.

18. The method of claim 17, wherein the patient specific data corresponds to at least one of bed time, average hours of sleep, height, weight, neck circumference, Epworth sleepiness scale, blood pressure, diagnostic respiratory disturbance index, therapeutic respiratory disturbance index, minimum oxygen saturation, body mass index, and sleep facility name.

19. The method of claim 17, wherein at least one of the device and the equipment is a ventilator, a sleep apnea device, a pressure delivery system, an oximeter, a ventilatory support system, an oxygen concentrator, a pressure support device, a mask, a filter, a humidifier and tubing.

20. The method of claim 11, further comprising entering data to the database using a screen that includes at least one of (a) a field for specifying a type of medical device used by such a patient and (b) a field for specifying a healthcare provider or health insurance provide for by such a patient.

21. The method of claim 11, further comprising the steps of:
creating the database on a computing system;
transmitting the data to the computing system; and
entering at least a portion of the data into a predetermined one of the plurality of disparate data fields.

22. The method of claim 21, wherein transmitting the data is performed using a telecommunications data link or a temporary storage medium.

23. The method of claim 11, wherein the database comprises relational tables resident on a computing system and associating the plurality of disparate data fields on one another.

24. A medical information management system, comprising:
a database of information for a plurality of patients, wherein the database includes a plurality of disparate data fields containing data for each patient in the database;
a user interface in communication with the database and configured to accept user input and transmit system output; and
report generating means for organizing at least a portion of the plurality of disparate data fields for multiple patients according to a sort criterion, formatting the organized portion of the plurality of disparate data fields in a presentable report, and transmitting the report through the user interface.

25. The system of claim 24, wherein the report generating means groups at least a portion of the plurality of disparate data fields into at least one set.

26. The system of claim 24, wherein the data in the plurality of disparate data fields corresponds to at least one of a patient name, a patient address, a patient identification number, patient contact information, patient social security number, patient date of birth, patient gender, patient marital status, patient ethnic category, patient occupation, patient disorder data, patient surgical data, patient medication, functional outcomes of sleep questionnaire inputs and results, insurance provider, insurance policy number, insurance group number, policy holder name, policy holder relationship, comments, patient photographic image, referring physician data, primary care provider data, home care provider data, clinician data, contact date, contact time, contact name, contact information, home visit date, recommended contact date, recommended device repair date, recommended device maintenance date, device type, device characteristics, device serial number, device prescription, prescription compliance data, device compliance data, compliance data, device usage dates, device usage information, session information, device physical settings, testing criteria, test inputs, testing results, equipment data, equipment replacement data, equipment maintenance data, facility data, therapy time, electronic communication data, database identification, file data, device/equipment images and patient specific data.

27. The system of claim 26, wherein the patient specific data corresponds to at least one of bed time, average hours of sleep, height, weight, neck circumference, Epworth sleepiness scale, blood pressure, diagnostic respiratory disturbance index, therapeutic respiratory disturbance index, minimum oxygen saturation, body mass index, and sleep facility name.

28. The system of claim 26, wherein at least one of the device and the equipment is a ventilator, a sleep apnea device, a pressure delivery system, an oximeter, a ventilatory support system, an oxygen concentrator, a pressure support device, a mask, a filter, a humidifier and tubing.

29. The system of claim 24, further comprising a device interface module in communication with the database and configured to receive, manage, and transmit data to the database via at least one of a telecommunications data link and a temporary storage medium.

30. The system of claim 24, further comprising means for causing the visual display to display a screen that includes at least one of (a) a field for specifying a type of medical device used by such a patient and (b) a field for specifying a healthcare provider or health insurance provide for by such a patient.

31. The system of claim 24, further comprising means for causing the visual display to display data associated with an individual patient on a patient home page that includes a patient display field displaying patient identifying information and a reminder field displaying information pertaining to an action to be taken for such a patient.

32. A medical information management system, comprising:
a database of information for a plurality of patients, wherein a plurality of disparate data fields containing data are provided for each patient in the database;
a user interface in communication with the database and configured to accept user input and transmit system output;
processing means for selecting at least one of the plurality of disparate data fields, comparing data associated with the selected data field with a data field threshold value, and presenting a signal to a user responsive to the selected data field data reaching the data field threshold value.

33. The system of claim 32, wherein the signal is at least one of an audible alarm and a visual display.

34. The system of claim 32, wherein the signal is a visual display and includes a message.

35. The system of claim 34, wherein the message is user-defined.

36. The system of claim 35, wherein data associated with an individual patient is displayed on a patient home page that includes a patient display field displaying patient identifying information and a reminder field displaying the message.

37. The system of claim 32, wherein the data in the plurality of disparate data fields corresponds to at least one of a patient name, a patient address, a patient identification number, patient contact information, patient social security number, patient date of birth, patient gender, patient marital status, patient ethnic category, patient occupation, patient disorder data, patient surgical data, patient medication, insurance provider, insurance policy number, insurance group number, policy holder name, policy holder relationship, comments, patient photographic image, referring physician data, primary care provider data, home care provider data, clinician data, contact date, contact time, contact name, contact information, home visit date, recommended contact date, recommended device repair date, recommended device maintenance date, device type, device characteristics, device serial number, device prescription, prescription compliance data, device compliance data, compliance data, device usage dates, device usage information, session information, device physical settings, testing criteria, test inputs, testing results, equipment data, equipment replacement data, equipment maintenance data, facility data, therapy time, electronic communication data, database identification, file data, device/equipment images and patient specific data.

38. The system of claim 37, wherein the patient specific data corresponds to at least one of bed time, average hours of sleep, height, weight, neck circumference, Epworth sleepiness scale, blood pressure, diagnostic respiratory disturbance index, therapeutic respiratory disturbance index, minimum oxygen saturation, body mass index, and sleep facility name.

39. The system of claim 37, wherein at least one of the device and the equipment is a ventilator, a sleep apnea device, a pressure delivery system, an oximeter, a ventilatory support system, an oxygen concentrator, a pressure support device, a mask, a filter, a humidifier and tubing.

40. The system of claim 32, wherein the processing means causes the user interface to display a screen that includes at least one of (a) a field for specifying a type of medical device used by such a patient and (b) a field for specifying a healthcare provider or health insurance provide for by such a patient.

41. The system of claim 32, wherein the database comprises relational tables resident on a computing system and associating the plurality of disparate data fields on one another.

42. The system of claim 32, further comprising a device interface module in communication with the database and configured to receive, manage, and transmit data to the database via at least one of a telecommunications data link and a temporary storage medium.
